(19) United States
(12) Patent Application Publication
(10) Pub. No.: US 2024/0172188 A1
(43) Pub. Date: May 23, 2024

(54) METHOD PERFORMED BY USER EQUIPMENT, AND USER EQUIPMENT

(71) Applicant: SHARP KABUSHIKI KAISHA, Sakai City, Osaka (JP)

(72) Inventors: CHAO LUO, Shanghai (CN); Yinan Zhao, Shanghai (CN); RENMAO LIU, Shanghai (CN)

(21) Appl. No.: 18/284,402

(22) PCT Filed: Apr. 1, 2022
(86) PCT No.: PCT/CN2022/084772

§ 371 Date: Sep. 27, 2023

(30) Foreign Application Priority Data
Apr. 2, 2021 (CN) 202110364948.5

(51) Int. Cl. H04W 72/04; H04W 72/0446

(52) U.S. Cl. CPC H04W 72/04; H04W 72/0446

(57) ABSTRACT

Provided in the present invention are a method performed by user equipment, and user equipment. The method performed by user equipment includes: acquiring one or more pieces of information related to inter-UE coordination, the one or more pieces of information including configuration information of a resource pool set, a slot set, a sensing window, and a coordination resource window; and determining, according to SCI detected in the sensing window and the resource pool set, several resources located in the coordination resource window and satisfying a first resource collision condition. The first resource collision condition includes: resources in the same slot in the coordination resource window being reserved in two or more SCIs detected in the sensing window, and the slot belonging to the slot set.

### TECHNICAL FIELD

The present invention relates to a method performed by user equipment, and user equipment.

### BACKGROUND

SL communication (e.g., when SL resource allocation mode 2 is configured) can support inter-UE coordination functions, e.g., coordination of resource (e.g., SL resources) allocation between two or more UEs. For the inter-UE coordination functions, problems such as definition, transmission, reception, etc., of inter-UE coordination messages need to be solved.

### Prior Art Documents

### Non-Patent Documents

Non-Patent Document 1: RP-152293, New WI proposal: Support for V2V services based on LTE sidelink
Non-Patent Document 2: RP-170798, New WID on 3GPP V2X Phase 2
Non-Patent Document 3: RP-170855, New WID on New Radio Access Technology
Non-Patent Document 4: RP-190766, New WID on 5G V2X with NR sidelink
Non-Patent Document 5: RP-201385, WID revision: NR sidelink enhancement

### SUMMARY

In order to solve at least some of the above problems, provided in the present invention are a method performed by user equipment and user equipment. A suitable filtering condition is set in the process of determining an inter-UE coordination resource set, so as to reduce SCIs that need to be analyzed and processed, thereby ensuring that an inter-UE coordination function is executed only for a destination UE or an SL connection satisfying a certain condition, while preventing a large number of messages indicating the same or similar inter-UE coordination resources from being present on an SL at the same time to block the SL.

According to the present invention, provided is a method performed by user equipment, comprising: acquiring one or more pieces of information related to inter-UE coordination, the one or more pieces of information comprising configuration information of a resource pool set, a slot set, a sensing window, and a coordination resource window; and determining, according to SCI detected in the sensing window and the resource pool set, several resources located in the coordination resource window and satisfying a first resource collision condition. The first resource collision condition comprises: resources in the same slot in the coordination resource window being reserved in two or more SCIs detected in the sensing window, and the slot belonging to the slot set.

In addition, according to the present invention, provided is a method performed by user equipment, comprising: determining SCI, wherein in a 1^{st}-stage SCI format corresponding to the SCI, one or more resources are indicated by “frequency resource assignment” and “time resource assignment” fields, and a combination of resource types respectively corresponding to the one or more resources is indicated by a “resource type” field; and transmitting the SCI.

In addition, according to the present invention, provided is a method performed by user equipment, comprising: determining a transmitting resource pool; and triggering a resource (re-)selection check according to a colliding resource indicated in a received inter-UE coordination message.

In addition, according to the present invention, provided is user equipment, comprising: a processor; and a memory, having instructions stored therein, wherein the instructions, when run by the processor, perform the aforementioned method.

Therefore, in the method provided in the present invention, a suitable filtering condition is set in the process of determining an inter-UE coordination resource set, so as to reduce SCIs that need to be analyzed and processed, thereby ensuring that an inter-UE coordination function is executed only for a destination UE or an SL connection satisfying a certain condition, while preventing a large number of messages indicating the same or similar inter-UE coordination resources from being present on an SL at the same time to block the SL.

### BRIEF DESCRIPTION OF THE DRAWINGS

The above and other features of the present invention will be more apparent from the following detailed description in combination with the accompanying drawings, in which:

FIG. 1 is a flowchart showing a method performed by user equipment according to Embodiment 1 of the present invention.

FIG. 2 is a flowchart showing a method performed by user equipment according to Embodiment 2 of the present invention.

FIG. 3 is a flowchart showing a method performed by user equipment according to Embodiment 3 of the present invention.

FIG. 4 shows a block diagram of user equipment (UE) according to the present invention.

### DETAILED DESCRIPTION

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

In the following description, a 5G mobile communication system and its later evolved versions are used as exemplary application environments to set forth a plurality of embodiments according to the present invention in detail. However, it is to be noted that the present invention is not limited to the following embodiments, but is applicable to many other wireless communication systems, such as a communication system after 5G and a 4G mobile communication system before 5G.

Some terms involved in the present invention are described below. Unless otherwise specified, the terms used in the present invention adopt the definitions herein. The terms given in the present invention may vary in LTE, LTE-Advanced, LTE-Advanced Pro, NR, and subsequent communication systems, but unified terms are used in the present invention. When applied to a specific system, the terms may be replaced with terms used in the corresponding system.
3GPP: 3^{rd} Generation Partnership Project
AGC: Automatic Gain Control
AMF: Access and Mobility Management Function
AS: Access Stratum
BWP: Bandwidth Part
CBR: Channel Busy Ratio
CP: Cyclic Prefix
CP-OFDM: Cyclic Prefix Orthogonal Frequency Division Multiplexing
CRB: Common Resource Block
CSI: Channel-State Information
DFT-s-OFDM: Discrete Fourier Transformation Spread Orthogonal Frequency Division Multiplexing
DL: Downlink
DM-RS: also referred to as DMRS, Demodulation Reference Signal
eNB: E-UTRAN Node B
E-UTRAN: Evolved UMTS Terrestrial Radio Access Network
FDRA: Frequency Domain Resource Assignment
FR1: Frequency Range 1
FR2: Frequency Range 2
GLONASS: GLObal Navigation Satellite System
gNB: NR Node B
GNSS: Global Navigation Satellite System
GPS: Global Positioning System
HARQ: Hybrid Automatic Repeat Request
HARQ-ACK: HARQ Acknowledgement
ID: Identity (or Identifier)
IE: Information Element
LSB: Least Significant Bit
LTE: Long Term Evolution
LTE-A: Long Term Evolution-Advanced
MAC: Medium Access Control
MAC CE: MAC Control Element
MIB: Master Information Block
MIB-SL: Master Information Block-Sidelink
MIB-SL-V2X: Master Information Block-Sidelink-Vehicle to Everything
MIB-V2X: Master Information Block-Vehicle to Everything
MME: Mobility Management Entity
MSB: Most Significant Bit
NAS: Non-Access Stratum
NDI: New Data Indicator
NR: “New Radio”, fifth generation radio access technology
OFDM: Orthogonal Frequency Division Multiplexing
P2V: Pedestrian-to-Vehicle
P2X: Pedestrian-to-everything
PBCH: Physical Broadcast Channel
PDCCH: Physical Downlink Control Channel
PDCP: Packet Data Convergence Protocol.
PSBCH: Physical Sidelink Broadcast Channel
PSCCH: Physical Sidelink Control Channel
PSFCH: Physical Sidelink Feedback Channel
PSSCH: Physical Sidelink Shared Channel
PRB: Physical Resource Block
PSS: Primary Synchronization Signal
PSS-SL: Primary Synchronization Signal for Sidelink
PSSS: Primary Sidelink Synchronization Signal
QZSS: Quasi-Zenith Satellite System
RB: Resource Block
RBG: Resource Block Group
RE: Resource Element
RLC: Radio Link Control
RRC: Radio Resource Control
RV: Redundancy Version
S-BWP: Sidelink Bandwidth Part
S-MIB: Sidelink Master Information Block
S-PSS: Sidelink Primary Synchronization Signal
S-SSB: Sidelink SS/PBCH Block (Sidelink Synchronization Signal/Physical Broadcast Channel Block)
S-SSS: Sidelink Secondary Synchronization Signal
SCI: Sidelink Control Information
SCS: Subcarrier Spacing
SIB: System Information Block
SL: Sidelink
SL BWP: Sidelink Bandwidth Part
SL MIB: Sidelink Master Information Block
SL PSS: Sidelink Primary Synchronization Signal
SL SS: Sidelink Synchronization Signal
SL SSID: Sidelink Synchronization Signal Identity (or Sidelink Synchronization Signal Identifier)
SL SSB: Sidelink SS/PBCH Block (Sidelink Synchronization Signal/Physical Broadcast Channel Block)
SL SSS: Sidelink Secondary Synchronization Signal
SL-SCH: Sidelink Shared Channel
SLSS: Sidelink Synchronization Signal
SLSS ID: Sidelink Synchronization Signal Identity (or Sidelink Synchronization Signal Identifier)
SLSSID: Sidelink Synchronization Signal Identity (or Sidelink Synchronization Signal Identifier)
SSB: SS/PBCH Block (Synchronization Signal/Physical Broadcast Channel Block)
SSB-SL: SS/PBCH Block for Sidelink (Sidelink Synchronization Signal/Physical Broadcast Channel Block)
SSS: Secondary Synchronization Signal
SSS-SL: Secondary Synchronization Signal for Sidelink
SSSB: Sidelink SS/PBCH Block (Sidelink Synchronization Signal/Physical Broadcast Channel Block)
SSSS: Secondary Sidelink Synchronization Signal
Sub-channel: Sub-channel
S-GW: Serving Gateway
TB: Transport Block
UE: User Equipment
UL: Uplink
UMTS: Universal Mobile Telecommunications System
UPF: User Plane Function
V2I: Vehicle-to-Infrastructure
V2N: Vehicle-to-Network
V2P: Vehicle-to-Pedestrian
V2V: Vehicle-to-Vehicle
V2X: Vehicle-to-Everything
VRB: Virtual Resource Block

Unless otherwise specified, in all embodiments and implementations of the present invention:
Optionally, “the first slot in the slot set S later than the slot n” refers to the first slot that is in the slot set S and that is temporally later than the slot n. The slot n may be in the slot set S, or may not be in the slot set S. For example, if the slot set S={1, 3, 5}, and the slot n=2, then the first slot in the slot set S later than the slot n is the slot 3. As another example, if the slot set S={1, 3, 5}, and the slot n=3, then the first slot in the slot set S later than the slot n is the slot 5.
Optionally, “the first slot in the slot set S not earlier than the slot n” refers to the first slot that is in the slot set S and that is temporally not earlier than the slot n. The slot n may be in the slot set S, or may not be in the slot set S. For example, if the slot set S={1, 3, 5}, and the slot n=2, then the first slot in the slot set S not earlier than the slot n is the slot 3. As another example, if the slot set S={1, 3, 5}, and the slot n=3, then the first slot in the slot set S not earlier than the slot n is the slot 3.
Optionally, “the last slot in the slot set S earlier than the slot n” refers to the last slot that is in the slot set S and that is temporally earlier than the slot n. The slot n may be in the slot set S, or may not be in the slot set S. For example, if the slot set S={1, 3, 5}, and the slot n=4, then the last slot in the slot set S earlier than the slot n is the slot 3. As another example, if the slot set S={1, 3, 5}, and the slot n=5, then the last slot in the slot set S earlier than the slot n is the slot 3.
Optionally, “the last slot in the slot set S not later than the slot n” refers to the last slot that is in the slot set S and that is temporally not later than the slot n. The slot n may be in the slot set S, or may not be in the slot set S. For example, if the slot set S={1, 3, 5}, and the slot n=4, then the last slot in the slot set S not later than the slot n is the slot 3. As another example, if the slot set S={1, 3, 5}, and the slot n=3, then the last slot in the slot set S not later than the slot n is the slot 3.
Optionally, “send” and “transmit” are interchangeable with each other where applicable.
Optionally, “symbol” may refer to an OFDM symbol where applicable.
Optionally, any two of “within X”, “in X”, and “on X” are interchangeable with each other where applicable (for example, when one or more operations are performed on one or more resources). X may be one or more carriers (e.g., an SL carrier), or one or more BWPs (e.g., an SL BWP), or one or more resource pools (or sidelink resource pools), or one or more links (e.g., a UL, a DL, or an SL), or one or more channels (e.g., a PSSCH), or one or more sub-channels, or one or more RBGs, or one or more RBs, or one or more “occasions” (e.g., a PDCCH monitoring occasion, a PSSCH transmission occasion, a PSSCH reception occasion, a PSFCH transmission occasion, a PSFCH reception occasion, or the like), or one or more OFDM symbols, or one or more slots, or one or more subframes, or one or more half-frames, or one or more frames, or one or more arbitrary time-domain and/or frequency-domain and/or code-domain and/or spatial-domain resources, etc.
Optionally, “higher layer” may refer to one or more protocol layers or protocol sub-layers above a physical layer, such as a MAC layer, an RLC layer, a PDCP layer, a PC5-RRC layer, a PC5-S layer, an RRC layer, a V2X layer, an application layer, a V2X application layer, or the like.
Optionally, “pre-configure” may be pre-configuration performed in a higher-layer protocol, such as pre-configured in a specific storage location in the UE (for example, pre-configured according to the specification of the higher layer protocol), or pre-configured in a specific storage location that can be accessed by the UE (for example, pre-configured according to the specification of the higher layer protocol).
Optionally, “configuration” may be configuration performed in a higher layer protocol by means of signaling. For example, configuration is performed for the UE by means of RRC signaling.
Optionally, “configured” may be replaced with “pre-configured”, and vice versa.
Optionally, “configured” may be replaced with “configured or pre-configured”, and vice versa.
Optionally, “a certain parameter has been configured” may be replaced with “a certain parameter has been provided”, and vice versa.
Optionally, “indicating certain information by means of a certain parameter” may be replaced with “providing certain information by means of a certain parameter”, and vice versa.
Optionally, “providing certain information by means of a certain parameter” may be replaced with “configuring certain information by means of a certain parameter”, and vice versa.
Optionally, “a certain parameter is configured” may be replaced with “a certain parameter is signaled”, and vice versa.
Optionally, “not configured” may be replaced with “not pre-configured”, and vice versa.
Optionally, “not configured” may be replaced with “not configured and/or not pre-configured”, and vice versa.
Optionally, “not configured” may be replaced with “not (pre-)configured”, and vice versa.
Optionally, the parameter Xmay refer to “X-r8”, or X-r9″, or “X-r10”, or “X-r11”, or “X-r12” or “X-r13” or “X-r14” or “X-r15” or “X-r 16”, or “X-r 17”, or the like where applicable (e.g., in the case that no ambiguity is caused), and vice versa. For example, “pdsch-HARQ-ACK-CodebookList” may be used to refer to a parameter “pdsch-HARQ-ACK-CodebookList-r 16” where applicable, and vice versa.
Optionally, a time-domain resource may also be referred to as a time resource.
Optionally, a frequency-domain resource may also be referred to as a frequency resource.
Optionally, a resource block may refer to a virtual resource block (VRB), or may refer to a physical resource block (PRB), or may refer to a common resource block (CRB), or may refer to a resource block defined in another manner.
Optionally, frequency-domain resource numbers may start from 0. For example, if the number of sub-channels (or subchannels) configured in a resource pool is N_{subChannel}^{SL}, the set of sub-channels in the resource pool may be represented by a set of corresponding sub-channel numbers as {0, 1, . . . , N_{subChannel}^{SL}−1}. As another example, a set of subcarriers in a resource block may be represented by a set of corresponding subcarrier numbers as {0, 1, . . . , 11}.
Optionally, time-domain resource numbers may start from 0. For example, for 30 kHz SCS, a set of slots in a subframe may be represented by a set of corresponding slot indexes as {0, 1}.
Optionally, “SCI” may refer to an instance of an SCI format (e.g., SCI format 1-A), or a combination of an instance of a 1^{st}-stage SCI format (e.g., SCI format 1-A) and an instance of a corresponding 2^{nd}-stage SCI format (e.g., SCI format 2-A), where applicable. For example, in a received SCI format 1-A, each field corresponds to a determined value. As another example, in an SCI format 1-A for transmission (or, to be transmitted), a value has been determined (or is to be determined) for each field. As another example, in a received SCI format 1-A and a corresponding SCI format 2-A, each field of each SCI format corresponds to a determined value.
Optionally, “SL transmission” may include one or more of the following:
   PSSCH transmission.
   PSCCH and PSSCH transmission.
   PSCCH or PSSCH transmission.
   PSFCH transmission.
   S-SSB Transmission.
Optionally, “PSSCH transmission” may be replaced with “PSCCH and/or PSSCH transmission” or replaced with “PSCCH/PSSCH transmission”.
Optionally, “SL resources” may include one or more of the following:
   PSSCH.
   PSCCH and PSSCH.
   PSCCH or PSSCH.
   PSFCH.
   S-SSB.
Optionally, if a resource pool and another resource pool correspond to the same frequency-domain resource (e.g., the same sub-channel set) and the same time-domain resource (e.g., the same slot set), then the two resource pools may be considered to be the same resource pool.

In communication based on device to device (D2D) technology, an interface between devices (also referred to as user equipment (UE)) may be referred to as a PC5 interface, and a corresponding transmission link on a physical layer may be referred to as a “direct link” or “sidelink” (SL for short) so as to be distinguished from an uplink (UL for short) and a downlink (DL for short). Communication based on an SL may be referred to as sidelink (SL) communication, and a corresponding carrier may be referred to as an SL carrier. An SL based on LTE technology may be referred to as an LTE SL. An SL based on NR technology may be referred to as an NR SL. 5G V2X communication may be based on an LTE SL or an NR SL. Hereinafter, unless otherwise specified, “SL” refers to an NR SL, “SL communication” refers to NR SL communication, and “V2X communication” refers to NR SL-based V2X communication.

A physical layer of an SL can support transmissions In one or more modes, such as broadcast transmission, groupcast transmission, unicast transmission, and the like, in one or more of in-coverage, out-of-coverage, and partial-coverage scenarios.

For frequency range 1 (FR1), a subcarrier spacing (SCS, denoted as Δƒ_{SL}) corresponding to the SL may be 15 kHz (normal CP), or 30 kHz (normal CP), or 60 kHz (normal CP or extended CP). For frequency range 2 (FR2), an SCS corresponding to the SL may be 60 kHz (normal CP or extended CP), or 120 kHz (normal CP). Each SCS corresponds to one SCS configuration (denoted as μ_{SL}). For example, Δƒ_{SL}=15 kHz corresponds to μ_{SL}=0, Δƒ_{SL}=30 kHz corresponds to μ_{SL}=1, Δƒ_{SL}=60 kHz corresponds to μ_{SL}=2, Δƒ_{SL}=120 kHz corresponds to μ_{SL}=3, and so on. As another example, for any given μ_{SL}, Δƒ_{SL}=2^{μ}^{_{SL}}·15 kHz. μ_{SL} may be an SCS configuration of an SL carrier. For example, all SL transmissions in one SL carrier use the same SCS configuration and/or the same CP. μ_{SL} may be an SCS configuration of a sidelink bandwidth part (SL BWP, or referred to as S-BWP, or referred to as SBWP, or referred to as SL-BWP, or referred to as BWP-SL, or referred to as BWP for short). For example, all SL transmissions in one SL BWP use the same SCS configuration and/or the same CP. μ_{SL} may be an SCS configuration of a resource pool. For example, all SL transmissions in one resource pool use the same SCS configuration and/or the same CP.

Signals and channels related to SL operations may include:
an SL PSS (sidelink primary synchronization signal), or referred to as an S-PSS, or referred to as an SPSS, or referred to as an SL-PSS, or referred to as a PSS-SL, or referred to as a PSSS (primary sidelink synchronization signal), or the like;
an SL SSS (sidelink secondary synchronization signal), or referred to as an S-SSS, or referred to as an SSSS (sidelink secondary synchronization signal), or referred to as an SL-SSS, or referred to as an SSS-SL, or referred to as an SSSS (secondary sidelink synchronization signal), or the like;
a PSBCH (physical sidelink broadcast channel);
a PSCCH (physical sidelink control channel);
a PSSCH (physical sidelink shared channel); and
a PSFCH (physical sidelink feedback channel).

The SL PSS, the SL SSS, and the PSBCH may be organized together into a block on time/frequency resources. The block is referred to as, for example, an S-SSB (sidelink synchronization signal/PSBCH block, or SSS/PSBCH block), or is referred to as an SSS/PSBCH block, or is referred to as an SS/PSBCH block, or is referred to as an S-SS/PSBCH block, or is referred to as an SL SSB, or is referred to as an SSSB, or is referred to as an SL-SSB, or is referred to as an SSB-SL. A transmission bandwidth (for example, 11 resource blocks) of the S-SSB may be located in a corresponding SL carrier (for example, located in one SL BWP configured in the SL carrier). The SL PSS and/or the SL SSS may carry an SL SSID (sidelink synchronization identity, or sidelink synchronization identifier, or sidelink synchronization signal identity, or sidelink synchronization signal identifier, or sidelink identity, or physical-layer sidelink identity, or referred to as SL-SSID, or referred to as SSID-SL, or referred to as SLSSID, or referred to as SLSS ID, or referred to as S-SSID, or the like), and the PSBCH may carry an SL MIB (sidelink master information block, or referred to as SL-MIB, or referred to as S-MIB, or referred to as MIB-SL, or referred to as MasterinformationBlockSidelink), which is configured by means of, for example, a parameter masterInformationBlockSidelink.

On the SL, a time-domain resource and/or a frequency-domain resource used to transmit the S-SSB may be configured by means of higher-layer parameter(s). For example, in the frequency domain, a location of the S-SSB in the frequency domain may be configured by means of a parameter absoluteFrequencySSB-SL (or a parameter sl-AbsoluteFrequencySSB). For another example, in the time domain, one or more synchronization configuration items may be configured by means of a parameter sl-SyncConfigList. In each synchronization configuration item, N_{period}^{S-SSB} S-SSBs within an S-SSB period having a length of 16 frames can be configured by means of a parameter numSSBwithinPeriod-SL (or a parameter sl-NumSSB-WithinPeriod). The index of a slot where an S-SSB having a number (or an index) of i_{S-SSB} (0≤i_{S-SSB}≤N_{period}^{S-SSB}−1) is located in the period having a length of 16 frames may be N_{offset}^{S-SSB}+(Nᵢₙₜₑᵣᵥₐₗ^{S-SSB}+1)·i_{S-SSB}, wherein N_{offset}^{S-SSB} may be configured by means of a parameter timeOffsetSSB-SL (or a parameter sl-TimeOffsetSSB), and Nᵢₙₜₑᵣᵥₐₗ^{S-SSB} may be configured by means of a parameter timeIntervalSSB-SL (or a parameter sl-TimeInterval).

A synchronization source (or referred to as a synchronization reference, or referred to as a synchronization reference source) related to SL synchronization may include a GNSS (global navigation satellite system, a gNB, an eNB, and a UE (for example, NR UE, or LTE UE, or NR UE or LTE UE). A UE serving as a synchronization source (for example, a UE transmitting the S-SSB) may be referred to as SyncRefUE.

Examples of the GNSS may include GPS (Global Positioning System), GLONASS (GLObal NAvigation Satellite System), BeiDou (Beidou Navigation Satellite System), Galileo (Galileo Navigation Satellite System), QZSS (Quasi-Zenith Satellite System), etc.

One or more (e.g., one) SL BWPs may be configured in one SL carrier, and one or more resource pools (or referred to as SL resource pools) may be configured within one SL BWP. One resource pool may be considered to be a set of time-domain and frequency-domain resources, and the time-domain and frequency-domain resources may be used for SL transmission and/or reception (optionally, the SL transmission and/or reception described herein does not include S-SSB transmission and/or reception).

For each SL BWP, a starting symbol that can be used for the SL may be configured by means of a parameter startSLsymbols (or a parameter sl-StartSymbol) (for example, the symbol is numbered as lₛₜₐᵣₜ^{SL} in the slot), and the number of symbols that can be used for the SL may be configured by means of a parameter lengthSLsymbols (or a parameter sl-LengthSymbols) (for example, the number of symbols is denoted as N_{length}^{SL}). The N_{length}^{SL} symbols may be consecutive symbols. A value set of lₛₜₐᵣₜ^{SL} may be denoted as Sₛₜₐᵣₜ^{SL}, for example, Sₛₜₐᵣₜ^{SL}={0, 1, 2, 3, 4, 5, 6, 7}, and a value set of N_{length}^{SL} may be denoted as S_{length}^{SL}, for example, S_{length}^{SL}={7, 8, 9, 10, 11, 12, 13, 14}. The “symbols that can be used for SL transmission” may be referred to as “SL symbols”. If a set of SL symbols (in chronological order) is denoted as

$$\{ {l}_{1}^{SL} , {l}_{2}^{SL} , … , {l}_{{N}_{length}^{SL}}^{SL} \} ,$$

then l₁^{SL}=lₛₜₐᵣₜ^{SL},

$${l}_{2}^{SL} = {l}_{start}^{SL} + 1 , … … , {l}_{{N}_{length}^{SL}}^{DL} = {l}_{start}^{SL} + {N}_{length}^{SL} - 1 \} .$$

For example, if lₛₜₐᵣₜ^{SL}=7 and N_{length}^{SL}=7, then the set of SL symbols is {7, 8, 9, 10, 11, 12, 13}. Optionally, the set of SL symbols may be applicable to all resource pools in the corresponding SL BWP. Optionally, the time-domain and frequency-domain resources corresponding to the S-SSB may be configured independently of the resource pool, and accordingly, the set of SL symbols is not applicable to S-SSB transmission and/or reception.

Only a slot meeting a certain condition can be configured to be used for the SL (e.g., used for SL transmission and/or reception). For example, such a slot is referred to as an “SL slot”, or a “candidate SL slot”, or an “SL candidate slot”, or a “slot that can be configured to be used for a certain resource pool” or a “slot that may belong to a certain resource pool”. A set of all slots within one SFN period (or one DFN period) is denoted as Tₐₗₗ={0,1, . . . ,10240×2^{μ}^{_{SL}}−1}, and a set of all “SL slots” within one SFN period (or one DFN period) is denoted as Tₐₗₗ^{SL}={t₀^{SL}, t₁^{SL}, . . . , t_{T}_{ₘₐₓ}₋₁^{SL}}, where Tₘₐₓ is the number of elements in the set Tₐₗₗ^{SL}. Optionally, for 0≤i<Tₘₐₓ, tᵢ^{SL} is numbered within the SFN period (or the DFN period), (i.e., 0≤tᵢ^{SL}<10240×2^{μ}^{_{SL}}). Optionally, t₀^{SL}<t₁^{SL}< . . . <t_{T}_{ₘₐₓ}₋₁^{SL}.

The set Tₐₗₗ^{SL} may be acquired by excluding the following slots from the set Tₐₗₗ:
A slot configured with an S-SSB (for example, the number of such slots is denoted as N_{S_SSB}).
A slot satisfying a first UL configuration condition (for example, the number of such slots is denoted as N_{nonSL}), wherein
   Optionally, for a slot t, the first UL configuration condition may be that: in the slot t, at least one of the symbols lₛₜₐᵣₜ^{SL}, lₛₜₐᵣₜ^{SL}+1, . . . , lₛₜₐᵣₜ^{SL}+N_{length}^{SL}−1 is not configured to be a UL symbol. The “configured to be a UL symbol” may be being configured to be a UL symbol in a semi-persistent manner, for example, configured by means of a parameter tdd-UL-DL-ConfigurationCommon, or configured by means of a parameter sl-TDD-Configuration, or configured by means of a parameter sl-TDD-Config.
A reserved slot. For example, optionally, the reserved slot may be determined in the following manners:
   A set of remaining slots resulting from excluding, from the set Tₐₗₗ, the N_{S_SSB} slots configured with an S-SSB and the N_{nonSL} slots satisfying the first UL configuration condition is denoted as

$${T}_{remaining} = \{ {l}_{0} , {l}_{1} , … , {l}_{10240 \times {2}^{μ} - {N}_{{S}_{SSB}} - {N}_{nonSL} - 1} \} .$$

Optionally, the slots in the set T_{remaining} are arranged in ascending order of slot indexes (or numbers).
If the slot lᵣ (0≤r<10240×2^{μ}−N_{S}_{_{SSB}}−N_{nonSL}) satisfies

$$r = ⌊ \frac{m \cdot ( 10240 > {2}^{μ} - {N}_{{S}_{SSB}} - {N}_{nonSL} )}{{N}_{reserved}} ⌋ ,$$

then the slot lᵣ is a reserved slot, where m=0, 1, . . . , N_{reserved-}−1, and N_{reserved}=(10240×2^{μ}−Nₛ_{_{SSB}}−N_{nonSL}) mod L_{reserved,thresh}^{SL}. L_{reserved,thresh}^{SL} may be a predefined or configured or pre-configured value, or one of a plurality of predefined or configured or pre-configured values (for example, a value determined from one of a plurality of predefined or configured or pre-configured values according to a resource pool to be configured).

For each resource pool (for example, denoted as u),
In the frequency domain, each sub-channel may consist of one or more resource blocks, and the specific number of the resource blocks (for example, referred to as a sub-channel size, such as denoted as n_{subCH,size}^{SL,u}) may be configured by means of a parameter (for example, sl-SubchannelSize). The n_{subCH,size}^{SL,u} resource blocks may be consecutive in the frequency domain.
In the frequency domain, the index (or the number) of a starting resource block of a starting sub-channel of the resource pool in the corresponding SL BWP may be configured by means of a parameter (e.g., sl-StartRB-Subchannel), and is denoted as, for example, n_{RB,start}^{SL,u}.
In the frequency domain, the number (for example, denoted as N_{subCH}^{SL,u}) of sub-channels occupied by the resource pool may be configured by means of a parameter (e.g., sl-NumSubchannel). The N_{subCH}^{SL,u} sub-channels may be consecutive in the frequency domain.
In the frequency domain, the number (denoted as N_{PRB}^{SL,u}) of PRBs occupied by the resource pool may be configured by means of a parameter (e.g., sl-RB-Number). Optionally, the UE may assume that the last N_{PRB}^{SL,u}mod n_{subCH,size}^{SL,u} PRBs in the N_{PRB}^{SL,u} PRBs are not to be used.
In the frequency domain, sub-channels in a resource pool may be respectively numbered as 0, 1, . . . , N_{subch}^{SL}−1 in certain order (for example, in the order from low frequency to high frequency). A sub-channel numbered as i may be referred to as “sub-channel i” (0≤i≤N_{subch}^{SL}−1)
In the time domain, a slot bitmap (for example, corresponding bits are denoted as b₀, b₁, . . . , b_{L}_{_{bitmap}}_{^{SL,u}}₋₁, where L_{bitmap}^{SL,u} is the number of bits in the slot bitmap) may be configured by means of a parameter (for example, sl-TimeResource) to determine a subset (for example, denoted as Tᵤ^{SL}) of the set Tₐₗₗ^{SL}. The set Tᵤ^{SL} is the slot set of the resource pool. Specifically,
   Optionally, the set Tᵤ^{SL} may be initialized to be an empty set.
   Optionally, each k (for example, in ascending order of k) satisfying 0≤k≤10240×2^{μ}−N_{S}_{_{SSB}}−N_{nonSL}−N_{reserved} is denoted as k′=k mod L_{bitmap}^{SL,u}. If b_{k′}=1, then the slot tₖ^{SL} in the set Tₐₗₗ^{SL} belongs to the set Tᵤ^{SL} (or, the slot tₖ^{SL} in the set Tₐₗₗ^{SL} is added to the set Tᵤ^{SL}).
   Optionally, elements in the set Tᵤ^{SL} may be re-labeled as several slots having consecutive subscripts (for example, labeled according to the order of the elements being added to the set Tᵤ^{SL}, such as sequentially labeled as

$${t}_{0}^{{′}^{SL , u}} , {t}_{1}^{{′}^{SL , u}} , … … , {t}_{{T}_{max}^{{′}^{u}} - 1}^{{′}^{SL , u}} ) ,$$

i.e.,

$${T}_{u}^{SL} = \{ {t}_{0}^{{′}^{SL , u}} , {t}_{1}^{{′}^{SL , u}} , … , {t}_{{T}_{max}^{{′}^{u}} - 1}^{{′}^{SL , u}} \} ,$$

where T′ₘₐₓ^{u} is the number of elements in the set Tᵤ^{SL}.

Optionally, L_{reserved,thresh}^{SL} may be related to a resource pool to be configured. For example, for the resource pool u, L_{reserved,thresh}^{SL}=L_{bitmap}^{SL,u}.

A resource pool may be configured to be a “transmitting resource pool”, and resources therein may be used for data transmission and/or HARQ-ACK information reception in SL communication, etc.

A resource pool may also be configured to be a “receiving resource pool”, and resources therein may be used for data reception and/or HARQ-ACK information transmission in SL communication, etc.

Methods for allocating resources (such as time-domain resources, or frequency-domain resources, or code-domain resources, or spatial-domain resources) related to SL operations may include:
Mode 1 (or Resource Allocation Mode 1, or Sidelink Resource Allocation Mode 1): a base station schedules a resource for SL transmission.
Mode 2 (or Resource Allocation Mode 2, or Sidelink Resource Allocation Mode 2): UE determines a resource for SL transmission (i.e., the base station does not participate in scheduling of any resource for SL transmission). For example, UE performing an SL transmission operation autonomously determines a resource for SL transmission.

For an SL transmission, the transmitter may be referred to as TX UE, and the receiver may be referred to as RX UE.

One UE may correspond to (or be associated with) one or more “source layer-2 identifiers” (source layer-2 IDs or source layer-2 UE IDs) and/or one or more “destination layer-2 identifiers” (destination layer-2 IDs or destination layer-2 UE IDs), wherein
Optionally, a source layer-2 identifier may be an integer represented by several (e.g., 24) bits.
A destination layer-2 identifier may be an integer represented by several (e.g., 24) bits.
Optionally, several (e.g., eight) least significant bits of a “source layer-2 identifier” may be used as a “source layer-1 identifier” (source layer-1 ID or source layer-1 UE ID). Optionally, the “source layer-1 identifier” may be indicated in layer-1 signaling, for example, indicated in SCI.
Optionally, several (e.g., eight) least significant bits of a “destination layer-2 identifier” may be used as a “destination layer-1 identifier” (destination layer-1 ID or destination layer-1 UE ID). Optionally, the “destination layer-1 identifier” may be indicated in layer-1 signaling, for example, indicated in SCI.
Optionally, in an SL transmission in which the UE acts as the transmitter, the “source layer-2 identifier” may be used to indicate a source layer-2 identifier of the UE.
Optionally, in an SL unicast transmission in which the UE acts as the transmitter, the “destination layer-2 identifier” may be used to indicate a source layer-2 identifier of an expected receiver of the SL transmission.
Optionally, in an SL groupcast transmission in which the UE acts as the transmitter, the “destination layer-2 identifier” may be used to indicate a destination layer-2 identifier corresponding to (or associated with) the groupcast transmission.
Optionally, in an SL broadcast transmission in which the UE acts as the transmitter, the “destination layer-2 identifier” may be used to indicate a destination layer-2 identifier corresponding to (or associated with) the broadcast transmission.
Optionally, in an SL unicast transmission that is detected by the UE and that is from other UE, if the “destination layer-2 identifier” indicates a source layer-2 identifier of the UE, and the “source layer-2 identifier” indicates a destination layer-2 identifier of the UE, then it can be considered that the UE is an expected receiver of the SL transmission.
Optionally, in an SL groupcast transmission that is detected by the UE and that is from other UE, if the “destination layer-2 identifier” indicates a destination layer-2 identifier of the UE (for example, a destination layer-2 identifier for groupcast), then it can be considered that the UE is an expected receiver of the SL transmission.
Optionally, in an SL broadcast transmission that is detected by the UE and that is from other UE, if the “destination layer-2 identifier” indicates a destination layer-2 identifier of the UE (for example, a destination layer-2 identifier for broadcast), then it can be considered that the UE is an expected receiver of the SL transmission.

The UE may schedule data transmission by means of sidelink control information (SCI). The SL operations may support “two-stage SCI”. 1^{st}-stage SCI may include information such as resource reservation and/or resource assignment, so that all UEs monitoring the SL may perform sensing with respect to a resource reservation and/or resource allocation status. 2^{nd}-stage SCI may include other information, such as information related to HARQ feedback and the like.

Hereinafter, unless otherwise specified, when mentioned individually, “SCI” may refer to the 1^{st}-stage SCI, or the 2^{nd}-stage SCI, or the 1^{st}-stage SCI and the 2^{nd}-stage SCI, where applicable.

A format of the 1^{st}-stage SCI may be SCI format 1-A (or written as “SCI format 1_A”). The following are some examples of the information that can be included in SCI format 1-A:
priority;
frequency resource assignment;
time resource assignment;
resource reservation period;
DMRS pattern; and
2^{nd}-stage SCI format.

The maximum value (for example, denoted as Nᵣₑₛ^{max}) of the number of assigned and/or reserved and/or indicated resources (e.g., PSCCH/PSSCH resources) in each 1^{st}-stage SCI format may be a value configured or pre-configured by a higher layer protocol (for example, configured or pre-configured by means of a parameter sl-MaxNumPerReserve). The “assigned and/or reserved and/or indicated resources” may include a resource corresponding to a PSCCH corresponding to the 1^{st}-stage SCI format and/or a corresponding PSSCH. For example, if the “frequency resource assignment” and/or the “time resource assignment” corresponds to three resources, then the first resource may be a resource corresponding to a PSCCH corresponding to the 1^{st}-stage SCI format and/or a corresponding PSSCH (for example, referred to as “a resource corresponding to the current SL transmission”), and the other two resources may be two resources that are reserved and/or assigned by the 1^{st}-stage SCI format and that can be used for other SL transmissions (for example, resources used for retransmission performed in a future slot in the same transport block). The size of the “frequency resource assignment” field may be related to Nᵣₑₛ^{max}. For example, when Nᵣₑₛ^{,ax}=2, the size of the “frequency resource assignment” field is

$$⌈ {log}_{2} ( \frac{{N}_{subch}^{SL} ( {N}_{subch}^{SL} + 1 )}{2} ) ⌉$$

bits. As another example, when Nᵣₑₛ^{max}=3, the size of the “frequency resource assignment” field is

$$⌈ {log}_{2} ( \frac{{N}_{subChannel}^{SL} ( {N}_{subChannel}^{SL} + 1 ) ( 2 {N}_{subChannel}^{SL} + 1 )}{6} ⌉$$

bits. The size of the “time resource assignment” field may be related to Nᵣₑₛ^{max}. For example, when Nᵣₑₛ^{max}=2, the size of the “time resource assignment” field is five bits. As another example, when Nᵣₑₛ^{max}=3, the size of the “time resource assignment” field is nine bits.

A resource assigned and/or reserved and/or indicated by the 1^{st}-stage SCI format may be aperiodic. In addition, under a certain condition (for example, if a parameter sl-MultiReserveResource has been configured or pre-configured), the 1^{st}-stage SCI format may indicate, by means of a “resource reservation period” field, one of several “resource reservation periods” (or “resource reservation intervals”) configured or pre-configured by a higher layer protocol parameter (e.g., sl-ResourceReservePeriodList) (for example, the value of the indicated resource reservation period is denoted as Pᵣₛᵥₚ^{SL}). In this case, the 1^{st}-stage SCI may assign and/or reserve and/or indicate a resource that recurs periodically. For example, if resources indicated by the “frequency resource assignment” and/or the “time resource assignment” in the 1^{st}-stage SCI include a resource in the slot t′ₘ^{SL,u}, then the resource set assigned and/or reserved and/or indicated by the 1^{st}-stage SCI format not only includes the resource in the slot t′ₘ^{SL,u} but also includes resources that are in slots

$${t}_{m + 1 \times {P}_{rsvp}^{SL}}^{{′}^{SL , u}} , {t}_{m + 2 \times {P}_{rsvp}^{SL}}^{{′}^{SL , u}} , …$$

and that correspond to the same sub-channel set. Two resources at an interval of Pᵣₛᵥₚ^{SL} may be used to transmit two different TBs.

A format of the 2^{nd}-stage SCI may be SCI format 2-A (or written as “SCI format 2_A”) or SCI format 2-B (or written as “SCI format 2_B”) or another SCI format. The following are some examples of the information that can be included in the SCI format 2-A and/or SCI format 2-B:
source layer-1 identifier;
destination layer-1 identifier;
HARQ process ID, or HARQ process number;
new data indicator (NDI); and
redundancy version (RV).

The 1^{st}-stage SCI may be carried on a PSCCH. The 2^{nd}-stage SCI may be multiplexed, together with data to be transmitted, on a PSSCH associated with (or scheduled by) the PSCCH. The PSCCH and the PSSCH associated therewith may be multiplexed, in a certain manner, on the time-domain resource and/or the frequency-domain resource allocated for SL transmission (for example, a sub-channel where the starting resource block of the PSCCH is located may be the starting sub-channel of the PSSCH associated therewith. As another example, the starting resource block of the PSCCH may be the starting resource block of the starting sub-channel of the PSSCH associated therewith). In addition, it may be considered that the 1^{st}-stage SCI and/or the corresponding 2^{nd}-stage SCI schedules the corresponding PSSCH (or schedules transmission of the PSSCH, or schedules transmission of a TB carried on the PSSCH).

If HARQ feedback is enabled, the RX UE may feed back information (e.g., referred to as “HARQ-ACK information”) related to PSCCH and/or PSSCH reception by means of a PSFCH. For example, when the RX UE receives a PSSCH in a resource pool, and the value of an “HARQ feedback enabled/disabled indicator” field in the corresponding SCI is 1, the RX UE provides HARQ-ACK information by means of PSFCH transmission in the resource pool. Such HARQ-ACK information may be referred to as “HARQ-ACK information reported on the SL and related to the SL transmission”. In some configurations, the HARQ-ACK information reported on the SL and related to the SL transmission may indicate a positive acknowledgement (ACK or acknowledgement) indicating, for example, that data carried by a corresponding PSCCH and/or PSSCH can be correctly decoded, or may indicate a negative acknowledgement (NACK or NAK) indicating, for example, that data carried by a corresponding PSCCH and/or PSSCH cannot be correctly decoded. In some other configurations, the HARQ-ACK information reported on the SL and related to the SL transmission may indicate only NACK (for example, no HARQ-ACK feedback is transmitted when data carried by a corresponding PSCCH and/or PSSCH can be correctly decoded, whereas NACK is transmitted when data carried by a corresponding PSCCH and/or PSSCH cannot be correctly decoded). “ACK” and “NACK” may be referred to as HARQ-ACK values.

A RX UE, when performing SL reception, may receive only PSCCH and/or PSSCH transmission meeting an SL reception condition. The SL reception condition may include one or more of the following:
The combination of a source layer-1 identifier and/or a destination layer-1 identifier and/or a cast type (e.g., unicast, groupcast, or broadcast) determined according to SCI is consistent with one combination (e.g., one of one or more combinations) of a source layer-1 identifier and/or a destination layer-1 identifier and/or a cast type allowed for reception in the RX UE.
A source layer-2 identifier and/or a destination layer-2 identifier and/or a cast type determined according to SCI and/or a corresponding MAC PDU subheader is consistent with one combination (e.g., one of one or more combinations) of a source layer-2 identifier and/or a destination layer-2 identifier and/or a cast type allowed for reception in the RX UE.

In the time domain, PSFCH resources may recur periodically in a resource pool. For example, a corresponding period (referred to as, for example, “PSFCH period” or “PSFCH resource period,” e.g., denoted as N_{PSSCH}^{PSFCH}, and in units of, for example, the number of slots) may be configured by means of a parameter periodPSFCHresource (or a parameter sl-PSFCH-Period), and configured to be, for example, N_{PSSCH}^{PSFCH}=0, or N_{PSSCH}^{PSFCH}=1, or N_{PSSCH}^{PSFCH}=2, or N_{PSSCH}^{PSFCH}=4). N_{PSSCH}^{PSFCH}=0 may be used to indicate that no PSFCH resource is configured in a corresponding resource pool. For example, if a resource pool is not configured with any PSFCH-related parameter (such as a parameter sl-PSFCH-Config, or one or more parameters in the parameter sl-PSFCH-Config), or if the PSFCH period configured in the parameter sl-PSFCH-Config is 0, then it is indicated that the resource pool is not configured with any PSFCH resource. As another example, if a resource pool is configured with the parameter sl-PSFCH-Config, and if the value of the PSFCH period configured in the parameter sl-PSFCH-Config is not 0, then it is indicated that the resource pool is configured with a PSFCH resource.

A slot configured with a PSFCH resource may be referred to as “PSFCH slot”. Within one PSFCH slot, symbols related to PSFCH transmission may be the last one or more SL symbols of the slot. For example, for PSFCH format 0, the symbol lₛₜₐᵣₜ^{SL}+N_{length}^{SL}−1 may be used as a gap symbol, or a guard symbol, and the symbol lₛₜₐᵣₜ^{SL}+N_{length}^{SL}−2 may be used for PSFCH transmission. Content transmitted on the symbol lₛₜₐᵣₜ^{SL}+N_{length}^{SL}−2 may be copied to the symbol lₛₜₐᵣₜ^{SL+N}_{length}^{SL}−3(or, the symbol lₛₜₐᵣₜ^{SL}+N_{length}^{SL}−2 and the symbol lₛₜₐᵣₜ^{SL}+N_{length}^{SL}−3 are both used for PSFCH transmission). For UE that receives a PSFCH, the symbol lₛₜₐᵣₜ^{SL}+N_{length}^{SL}−3 may be used for automatic gain control (AGC). Other SL symbols in one PSFCH slot may be used to transmit other SL signals/channels, such as a PSCCH, a PSSCH, etc.

In SL resource allocation mode 2, allocated SL resources may be determined by using one or more methods. For example, a set of “available resources” (or “idle resources”) may be determined by using different methods, and then one or more SL resources for SL transmission are selected (e.g., randomly selected) from the set of “available resources” (or “idle resources”). In embodiments and implementations of the present invention, a method for determining a set of “available resources” may be referred to as “resource selection mechanism” or “resource selection method” or “resource selection scheme” or “resource determination mechanism” or “resource determination method” or “resource determination scheme” or “resource allocation mechanism” or “resource allocation method” or “resource allocation scheme” or the above names added with the prefix “SL” (such as “SL resource selection mechanism”), or the like. Alternatively, a set of all operations for determining allocated SL resources is referred to as “resource selection mechanism”. Alternatively, a set of some operations for determining allocated SL resources is referred to as “resource selection mechanism”.

If a UE uses a certain resource selection mechanism in SL resource allocation mode 2, the UE may be referred to as implementing, on the basis of the resource selection mechanism, SL resource allocation mode 2.

Operations corresponding to SL resource allocation mode 2 may include: in a slot n, requesting, by a higher layer protocol entity (e.g., a MAC layer protocol entity), a physical layer protocol entity to determine, according to an input parameter set (e.g., denoted as P_{A}), a resource subset (e.g., denoted as S_{A}) from which resource(s) may be selected, and reporting, by the physical layer protocol entity, the resource subset S_{A} to the higher layer protocol entity (e.g., the MAC layer protocol entity).

The input parameter set P_{A} may include one or more of the following:
A resource pool (e.g., denoted as uₛₑₗ) for performing resource selection. For example, the resource subset S_{A} may be a subset of a set of candidate resources in the resource pool uₛₑₗ.
A priority (e.g., a layer-1 priority, or a physical layer priority, e.g., denoted as prio_{TX}).
A remaining packet delay budget.
A resource size. For example, the “resource size” may include the number of sub-channels occupied by each resource (e.g., the number of consecutive sub-channels), e.g., denoted as L_{subcH}. As another example, the “resource size” may include the number of slots occupied by each resource (e.g., the number of consecutive slots), e.g., denoted as Lₛₗₒₜ. Optionally, L_{subCH} and/or Lₛₗₒₜ may be a predefined or configured or pre-configured value, e.g., Lₛₗₒₜ=1 (in this case, the resource may be referred to as a single-slot resource).
A resource reservation interval, e.g., denoted as P_{rsvp_TX}.
A resource set for a re-evaluation operation, e.g., denoted as (r₀, r₁, r₂, . . . ).
A resource set for a pre-emption operation, e.g., denoted as (r′₀, r′₁, r′₂, . . . ).

To determine the resource subset S_{A}, the set S_{A} may be initialized to be a set (e.g., denoted as Sₐₗₗ) consisting of all candidate resources, and then unavailable resources (e.g., resources reserved by other UEs) are removed from the set S_{A}, and the resulting set S_{A} is the requested resource subset.

The “set Sₐₗₗ consisting of all candidate resources” may be a set of all resources corresponding to L_{subCH} sub-channels and Lₛₗₒₜ slots in the resource pool uₛₑₗ and in a resource selection window (e.g., a time window corresponding to a time interval [n+T₁, n+T₂]), or a subset of the set (e.g., including only resources in a slot that can be used to transmit a PSCCH and/or a PSSCH, wherein, for example, in an SL symbol set configured in a certain slot in the resource pool uₛₑₗ, if the number of SL symbols that can be used to transmit a PSCCH and/or a PSSCH does not correspond to any PSSCH DMRS mode, then the slot cannot be used to transmit a PSCCH and/or a PSSCH, so that a resource in the slot may not belong to the set Sₐₗₗ). T₁ and T₂ may be two values determined by the UE and meeting a certain condition. For example, T₁ may be related to processing capabilities of the UE, and T₂ may be related to the remaining packet delay budget.

For a UE that applies SL resource allocation mode 2, the “unavailable resources” removed from the set S_{A} may include one or more of the following:
A resource that cannot be used to perform SL transmission thereon due to the transmission capability limitations of the UE. For example, due to the limitations on the number of simultaneous transmissions supported by the UE, the UE cannot perform SL transmission on an SL carrier corresponding to the set S_{A} when the UE is performing transmission on another carrier. As another example, due to the limitations on carrier combinations supported by the UE, the UE cannot perform SL transmission on an SL carrier corresponding to the set S_{A} when the UE is performing transmission on another carrier. As another example, because a requirement on the time required for tuning to a certain resource in the set S_{A} exceeds the capability of the UE, the UE cannot perform SL transmission on the resource.
An unavailable resource identified by the UE by means of a sensing operation. For example, resource reservation information (e.g., resource reservation information in SCI) transmitted on an SL (e.g., transmitted by another UE) is monitored, detected, or received, so as to determine a set of reserved resources, and/or a set of resources that cannot be determined as reserved or not reserved, and/or a set of resources that may result in a collision, and/or a set of allocated resources, and/or a set of resources that cannot be used for allocation, etc.
An unavailable resource indicated by another UE or a base station. For example, another UE monitors, detects, or receives resource reservation information (e.g., resource reservation information in SCI) transmitted on an SL, so as to determine a set of reserved resources, and/or a set of resources that cannot be determined as reserved or not reserved, and/or a set of resources that may result in a collision, and/or a set of allocated resources, and/or a set of resources that cannot be used for allocation, and/or a set of resources that are not preferentially allocated, etc. The other UE may indicate information related to these resources to the UE via signaling carried in the SL transmission.

The operations corresponding to SL resource allocation mode 2 may include: selecting, from the resource subset S_{A}, a resource for a PSSCH/PSCCH transmission (e.g., a PSSCH transmission, or a PSCCH transmission, or a PSSCH transmission and a PSCCH transmission multiplexed in the same resource).

The operations corresponding to SL resource allocation mode 2 may include: selecting, from the resource subset S_{A}, resources for a plurality of PSSCH/PSCCH transmissions.

The operations corresponding to SL resource allocation mode 2 may include: selecting, from the resource subset S_{A}, a transmission resource for a transport block, for example, selecting, from the resource subset S_{A}, a resource for an initial transmission of the transport block and each retransmission thereof.

The operations corresponding to SL resource allocation mode 2 may include: selecting, from the resource subset S_{A}, transmission resources for a plurality of transport blocks, for example, selecting, from the resource subset S_{A}, a resource for an initial transmission of each of the plurality of transport blocks and each retransmission thereof.

In SL resource allocation mode 2, a “random selection” method may be used to select a resource from the resource subset S_{A}. For example, a resource is selected from the resource subset S_{A} according to an equal probability method.

If a resource selection mechanism identifies an unavailable resource by means of a sensing operation, it can be considered that the resource selection mechanism is a “sensing-based resource selection mechanism”. The sensing operation may be “full sensing” (or simply “sensing”). For example, the UE must monitor all slots that are in a sensing window (e.g., a time window corresponding to a time interval [n−T₀, n−T_{proc,0}^{SL}) and/or a time window defined in another manner) and belong to (or may belong to) the resource pool uₛₑₗ except the slots that cannot be monitored due to some exceptional circumstances (e.g., the slots that cannot be monitored during SL transmission due to half-duplex limitations) and/or some special slots (e.g., slots that cannot be used to transmit a PSCCH and/or a PSSCH). T₀ may be configured by means of a higher-layer parameter (e.g., the parameter sl-Sensing Window), and T_{proc,0}^{SL} may be related to the processing capability of the UE. The corresponding resource selection mechanism may be referred to as “full sensing-based resource selection mechanism”, or “full sensing-based resource selection”, or simply “full sensing”, or simply, if no confusion will be caused, “sensing-based resource selection mechanism”, or “sensing-based resource selection”, or simply “sensing”.

The sensing operation may also be “partial sensing”. For example, the UE only needs to monitor some slots (e.g., some slots that recur periodically) that are in the sensing window and belong to (or may belong to) the resource pool uₛₑₗ. The corresponding resource selection mechanism may be referred to as “partial sensing-based resource selection mechanism”, or “partial sensing-based resource selection”, or simply “partial sensing”.

If a resource selection mechanism does not involve (or, does not perform) any sensing operation, it can be considered that the resource selection mechanism is “resource selection mechanism not based on sensing”. For example, the set S_{A} may be equal to the “set Sₐₗₗ consisting of all candidate resources”, or may be equal to a set acquired by removing some special sources from the “set Sₐₗₗ consisting of all candidate resources”. The special resources may include one or more of the following:
A resource in a slot that cannot be used to perform PSCCH/PSSCH transmission.
A resource that cannot be used to perform SL transmission thereon due to the transmission capability limitations of the UE.
An unavailable resource indicated by another UE or a base station.

The corresponding resource selection mechanism may be referred to as “random resource selection”, or simply “random selection”, or “random resource selection not based on sensing”.

In addition, there may also be “sensing-based random resource selection”. For example, in a sensing-based resource selection mechanism, if a sensing result cannot be applied due to a certain reason, or only part of a sensing result is applied, then the resource selection can be considered “sensing-based random resource selection”.

Different UEs may support different sets of resource selection mechanisms. For example, all UEs support “random resource selection”. As another example, some UEs support only “full sensing” and “random resource selection”. As another example, some UEs support only “partial sensing” and “random resource selection”. As another example, some UEs support “full sensing”, “partial sensing”, and “random resource selection”. The set of resource selection mechanisms supported by the UE may be denoted as M_{cap}.

In various SL resource selection mechanisms, it can be considered that “full sensing” consumes a relatively large amount of power (or energy), and is more suitable for UEs not sensitive to power consumption (e.g., a UE mounted on an automobile in V2V communication), and “partial sensing”, “random resource selection”, etc. consume a relatively small amount of power, and are more suitable for UEs sensitive to power consumption and/or communication scenarios sensitive to power consumption (e.g., a handheld device corresponding to “pedestrian” in V2P communication). In another aspect, “random resource selection” may be used as an exception addressing mechanism, or a fallback mechanism for another resource selection mechanism (e.g., “full sensing”) (e.g., in V2V communication, when no sensing result is temporarily available, fallback from “full sensing” to “random resource selection” may be performed). Hence, “random resource selection” may also be applied to UEs not sensitive to power consumption. Certainly, the disadvantage of SL resource selection mechanisms such as “partial sensing”, “random resource selection”, etc., is that the probability of collisions between resources selected by different UEs is increased.

The SL resource selection mechanisms such as “partial sensing”, “random resource selection”, etc., may be applied to SL communication as part of “SL power saving” characteristics. For example, “partial sensing” can only be used when “SL power saving” is enabled (or activated, or configured), and the like.

When “SL power saving” is enabled, the UE may be in one of a plurality of states (e.g., referred to as SL states, or SL modes, or SL communication methods, or the like) related to “SL power saving”, such as:
First SL state. For example, the first SL state may be an “SL non-power saving state”. For example, a UE in this SL state is not sensitive to power (or energy) consumption, and correspondingly, the used resource selection mechanism does not require particularly taking into consideration power (or energy) consumption. The first SL state may also be referred to as “first SL mode”, or “first SL communication method”, etc. The SL non-power saving state may also be referred to as “SL non-power saving mode”, or “SL non-power saving communication method”, etc. An example of the SL non-power saving communication method may be some specific V2X communication methods (e.g., V2V).
Second SL state. The second SL state may be an “SL power saving state”. For example, a UE in this SL state is relatively or extremely sensitive to power (or energy) consumption, and correspondingly, the used resource selection mechanism requires taking into consideration power (or energy) consumption. For example, use of a resource selection mechanism that has high power consumption is avoided or reduced. The second SL state may also be referred to as “second SL mode”, or “second SL communication method”, etc. The SL power saving state may also be referred to as “SL power saving mode”, or “SL power saving communication method”, etc. An example of the SL power saving communication method may be some specific V2X communication methods (e.g., V2P). Another example of the SL power saving communication method may be an SL communication method used for public security.

“SL power saving” may be enabled (or “activated”, or “configured”) or disabled (or deactivated) by means of a higher layer protocol parameter (e.g., referred to as sl-powerSavingConfig). For example, if the parameter sl-powerSavingConfig is not present (or not configured), it is indicated that “SL power saving” is not enabled or is disabled. As another example, if the parameter sl-powerSavingConfig is present (or configured), it is indicated that “SL power saving” is enabled. As another example, if the value of the parameter sl-powerSavingConfig (or a certain parameter in an information element corresponding to the parameter sl-powerSavingConfig) is a predefined value (e.g., “disabled”, “false”, or the like), it is indicated that “SL power saving” is not enabled or is disabled. As another example, if the value of the parameter sl-powerSavingConfig (or a certain parameter in an information element corresponding to the parameter sl-powerSavingConfig)is a predefined value (e.g., “enabled”, “true”, or the like), it is indicated that “SL power saving” is enabled.

If “SL power saving” is not enabled, the UE may be considered to be always in the first SL state.

The set M_{cap} of resource selection mechanisms supported by the UE may be related to the SL state that the UE is in. For example, if the UE is in the first SL state, the set M_{cap} is equal to a set M^{cap,1}. As another example, if the UE is in the second SL state, the set M_{cap} is equal to a set M_{cap,2}. Optionally, the set M_{cap,1} and the set M_{cap,2} may be the same or different. For example, the set M_{cap,1}is {full sensing}. As another example, the set M_{cap,1} is {full sensing, random resource selection}. As another example, the set M_{cap,1} is {full sensing, partial sensing, random resource selection}. As another example, the set M_{cap,2} may be {random resource selection}. As another example, the set M_{cap,2} may be {partial sensing, random resource selection}.

An inter-UE coordination function can be supported in SL communication, and used for, for example, coordination in resource (e.g., SL resources) allocation and/or reservation and/or indication between two or more UEs. Specifically, for example, a UE (e.g., referred to as UE A) may transmit an “inter-UE coordination message” to one or more other UEs (for example, collectively referred to as UE B). The “inter-UE coordination message” may indicate one (or more) resource sets.

Each resource indicated in an inter-UE coordination message transmitted from UE A to UE B may correspond to a “resource type” (or “resource state”, or “resource feature”, or “resource use”), such as one of the following:
“Reserved resource” (or “resource being reserved”, or “resource to be reserved”, or “resource for reservation”, or “allocated resource”, or “resource being allocated”, or “resource to be allocated”, or “resource for allocation”). For example, the resource has been reserved (or allocated) by UE A. Specifically, the resource may be reserved by UE A for a particular UE, for example, UE A itself, and as another example, UE B.
“Released resource” (or “resource being released”, or “resource to be released”, or “resource for release”). For example, UE A expects to release a resource reserved thereby in previously transmitted SCI. A cause of releasing the resource may be that the resource is selected for one (e.g., the last one) of several retransmissions of a TB, but UE A has received an acknowledgement of the TB before the slot corresponding to the resource arrives).
“Colliding resource”. For example, UE A detects a resource reservation collision in a slot and/or one or more sub-channels where the resource is located. Optionally, the “collision” may be a collision in a slot that has elapsed, and corresponding collision detection may be referred to as “post-collision detection”. Optionally, the “collision” may be a collision in a future slot (or referred to as a “potential collision”), and corresponding collision detection may be referred to as “pre-collision detection”.
“Preferred resource”. For example, UE A expects that UE B selects (or, preferentially selects) the resource during resource selection (for example, when UE B performs SL transmission to UE A).
“Non-preferred resource”. For example, UE A expects that UE B excludes (or, preferentially excludes) the resource during resource selection (for example, when UE B performs SL transmission to UE A).

An inter-UE coordination message may be triggered autonomously by a UE transmitting the inter-UE coordination message. For example, if UE A detects that resources respectively indicated (or reserved, or allocated) by UE B1 and UE B2 collide with each other, then UE A may transmit an inter-UE coordination message to indicate the colliding resources. The inter-UE coordination message may be transmitted in a broadcast or groupcast manner, or is respectively transmitted to UE B1 and UE B2 in a unicast manner.

An inter-UE coordination message may be triggered by an “inter-UE coordination request message” transmitted by one or more other UEs. In this case, the inter-UE coordination message may also be referred to as an “inter-UE coordination response message”. For example, UE B transmits an “inter-UE coordination request message” to UE A, and UE A transmits an “inter-UE coordination response message” to UE B as a response.

An inter-UE coordination message may be a physical layer message. For example, the inter-UE coordination message may be included in SCI (e.g., 1^{st}-stage SCI, or 2^{nd}-stage SCI). As another example, the inter-UE coordination message may be multiplexed in a PSSCH (for example, the inter-UE coordination message and 2^{nd}-stage SCI and/or an SL-SCH may be multiplexed in the same PSSCH transmission). As another example, the inter-UE coordination message may be multiplexed in a PSCCH (for example, the inter-UE coordination message and 1^{st}-stage SCI may be multiplexed in the same PSCCH transmission).

An inter-UE coordination message may be a higher layer (e.g., the MAC layer, or the RRC layer) message. For example, the inter-UE coordination message may be carried in a MAC CE. As another example, the inter-UE coordination message may be an RRC message.

An inter-UE coordination request message may be a physical layer message. For example, the inter-UE coordination request message may be included in SCI (e.g., 1^{st}-stage SCI, or 2^{nd}-stage SCI). As another example, the inter-UE coordination request message may be multiplexed in a PSSCH (for example, the inter-UE coordination request message and 2^{nd}-stage SCI and/or an SL-SCH may be multiplexed in the same PSSCH transmission). As another example, the inter-UE coordination request message may be multiplexed in a PSCCH (for example, the inter-UE coordination request message and 1^{st}-stage SCI may be multiplexed in the same PSCCH transmission).

An inter-UE coordination request message may be a higher layer (e.g., the MAC layer, or the RRC layer) message. For example, the inter-UE coordination request message may be carried in a MAC CE. As another example, the inter-UE coordination request message may be an RRC message.

A coordination resource indicated in an inter-UE coordination message may be determined by means of one or more SCIs detected on an SL (e.g., one or more SCIs detected in operations such as “sensing”). For example, it is determined according to a plurality of SCIs that a resource has been reserved by a plurality of other UEs. As another example, it is determined according to a plurality of SCIs that resources reserved by a plurality of other UEs overlap with each other (e.g., overlapping on one or more UEs).

The inter-UE coordination function may be activated (or “enabled”, or “configured”) or deactivated (or disabled) by means of a higher layer protocol parameter (e.g., referred to as sl-ueCoordConfig). For example, if the parameter sl-ueCoordConfig is not present (or not configured), it is indicated that the inter-UE coordination function is not activated. As another example, if the parameter sl-ueCoordConfig is present (or configured), it is indicated that the inter-UE coordination function is activated. As another example, if the value of the parameter sl-ueCoordConfig (or a certain parameter in an information element corresponding to the parameter sl-ueCoordConfig) is a predefined value (e.g., “disabled”, “false”, or the like), it is indicated that the inter-UE coordination function is not activated. As another example, if the value of the parameter sl-ueCoordConfig (or a certain parameter in an information element corresponding to the parameter sl-ueCoordConfig) is a predefined value (e.g., “enabled”, “true”, or the like), it is indicated that the inter-UE coordination function is activated.

### Embodiment 1

A method performed by user equipment according to Embodiment 1 of the present invention will be described below with reference to FIG. 1.

FIG. 1 is a flowchart showing a method performed by user equipment according to Embodiment 1 of the present invention.

As shown in FIG. 1, in Embodiment 1 of the present invention, the steps performed by the user equipment (UE) include: step S101 and step S103. Optionally, the method may further include step S105 (the dashed line indicates “optional” in FIG. 1).

Specifically, in step S101, one or more pieces of information related to inter-UE coordination is acquired.

Optionally, part or all of the “one or more pieces of information related to inter-UE coordination” is indicated by a first protocol layer entity of the UE (e.g., indicated by the first protocol layer entity of the UE to a second protocol layer entity of the UE performing step S101), for example, when Embodiment 1 of the present invention is triggered, and as another example, when step S101 is triggered.

Optionally, part or all of the “one or more pieces of information related to inter-UE coordination” is predefined information.

Optionally, part or all of the “one or more pieces of information related to inter-UE coordination” is configuration information of a higher layer protocol.

Optionally, part or all of the “one or more pieces of information related to inter-UE coordination” is pre-configuration information of a higher layer protocol.

Optionally, the “one or more pieces of information related to inter-UE coordination” includes “resource type” indication information (e.g., denoted as C_{res,set}^{SL,in}) wherein
Optionally, C_{res,set}^{SL,in} may indicate one or more of the following:
   A reserved resource.
   A released resource.
   A colliding resource.
   A preferred resource.
   A non-preferred resource.
      For example, the number of different resource types indicated by C_{res,set}^{SL,in} is denoted as N_{res,set}^{SL,in}.
Optionally, C_{res,set}^{SL,in} may be indicated by the first protocol layer entity to the second protocol layer entity.
Optionally, C_{res,set}^{SL,in} may be an input parameter for triggering Embodiment 1 of the present invention (or triggering step S101).
Optionally, C_{res,set}^{SL,in} may be a predefined or configured or pre-configured value.

Optionally, the “one or more pieces of information related to inter-UE coordination” includes configuration information related to a first time window (for example, denoted as a time interval [t_{sci,start}^{SL,in}, t_{sci,end}^{SL,in}], where t_{sci,start}^{SL,in} and t_{sci,end}^{SL,in} may be represented by slot indexes, or represented in another manner), wherein
Optionally, the first time window may be referred to as a “sensing window”.
Optionally, the start time of the first time window is related to the time of triggering Embodiment 1 of the present invention (or triggering step S101).
Optionally, the start time of the first time window is related to one or more input parameters for triggering Embodiment 1 of the present invention (or triggering step S101).
Optionally, the length of the first time window is related to one or more predefined or configured or pre-configured parameters.
Optionally, the length of the first time window is related to one or more input parameters for triggering Embodiment 1 of the present invention (or triggering step S101).

Optionally, the “one or more pieces of information related to inter-UE coordination” includes configuration information related to a second time window (for example, denoted as a time interval [t_{res,start}^{SL,in},t_{res,end}^{SL,in}], where t_{res,start}^{SL,in} and t_{res,end}^{SL,in} may be represented by slot indexes, or represented in another manner), wherein
Optionally, the second time window may be referred to as a “coordination window” or a “coordination resource window”.
Optionally, the start time of the second time window is related to the time of triggering Embodiment 1 of the present invention (or triggering step S101).
Optionally, the start time of the second time window is related to one or more input parameters for triggering Embodiment 1 of the present invention (or triggering step S101).
Optionally, the length of the second time window is related to one or more predefined or configured or pre-configured parameters.
Optionally, the length of the second time window is related to one or more input parameters for triggering Embodiment 1 of the present invention (or triggering step S101).

Optionally, the “one or more pieces of information related to inter-UE coordination” includes N_{ID} identifiers (for example, denoted as an identifier set Eᵢₙ^{SL}={e₀^{SL,in}, e₁^{SL,in}, . . . , e_{N}_{_{ID}}₋₁^{SL,in}})), wherein
Optionally, the set Eᵢₙ^{SL} may be a source layer-1 identifier set.
Optionally, the set Eᵢₙ^{SL} may be a source layer-2 identifier set.
Optionally, the set Eᵢₙ^{SL} may be a destination layer-1 identifier set.
Optionally, the set Eᵢₙ^{SL} may be a destination layer-2 identifier set.
Optionally, N_{ID} may be an integer greater than or equal to one.
Optionally, the set Eᵢₙ^{SL} may be indicated by the first protocol layer entity to the second protocol layer entity.
Optionally, the set Eᵢₙ^{SL} may be an input parameter for triggering Embodiment 1 of the present invention (or triggering step S101).
Optionally, the set Eᵢₙ^{SL} may be a predefined or configured or pre-configured set.

Optionally, the “one or more pieces of information related to inter-UE coordination” includes information about N_{LINK} SL “connections” (links) (for example, denoted as an SL connection set

$${L}_{in}^{SL} = \{ {l}_{0}^{SL , in} , {l}_{1}^{SL , in} , … , {L}_{{N}_{LINK} - 1}^{SL , in} \} ) ) ,$$

wherein
Optionally, lₖ^{SL,in} (0≤k<N_{LINK}) may correspond to one or more of the following (or, may consist of one or more of the following):
   A “destination ID”.
   A “source ID”.
   A “cast type”.
wherein
   When k is different, a combination of the “destination ID” and/or the “source ID” and/or the “cast type” corresponding to corresponding lₖ^{SL,in} may be different. For example, lₖ_{₁}^{SL,in} corresponds to the “destination ID”, and lₖ_{₂}^{SL,in} corresponds to the “destination ID” and the “source ID”.
   Optionally, the “source ID” may be a source layer-1 identifier.
   Optionally, the “source ID” may be a source layer-2 identifier.
   Optionally, the “destination ID” may be a destination layer-1 identifier.
   Optionally, the “destination ID” may be a destination layer-2 identifier.
   Optionally, the “cast type” may be unicast, or groupcast, or broadcast.
   Optionally, for unicast, lₖ^{SL,in} in corresponds to the “destination ID”, the “source ID”, and the “cast type”.
   Optionally, for groupcast, lₖ^{SL,in} corresponds to the “destination ID” and the “cast type”.
   Optionally, for broadcast, lₖ^{SL,in} corresponds to the “destination ID” and the “cast type”.
   Optionally, for unicast, lₖ^{SL,in} corresponds to the “destination ID” and the “source ID”.
   Optionally, for groupcast, lₖ^{SL,in} corresponds to the “destination ID”.
   Optionally, for broadcast, lₖ^{SL,in} corresponds to the “destination ID”.
   Optionally, if the “cast type” is unicast, lₖ^{SL,in} corresponds to the “destination ID” and the “source ID”.
   Optionally, if the “cast type” is groupcast, lₖ^{SL,in} corresponds to the “destination ID”.
   Optionally, if the “cast type” is broadcast, lₖ^{SL,in} corresponds to the “destination ID” .
Optionally, N_{LINK} may be an integer greater than or equal to one.
Optionally, the set Lᵢₙ^{SL} may be indicated by the first protocol layer entity to the second protocol layer entity.
Optionally, the set Lᵢₙ^{SL} may be an input parameter for triggering Embodiment 1 of the present invention (or triggering step S101).
Optionally, the set Lᵢₙ^{SL} may be a predefined or configured or pre-configured set.

Optionally, the “one or more pieces of information related to inter-UE coordination” includes configuration information of Nₚₒₒₗ resource pools (for example, denoted as a resource pool set U={u₀, u₁, . . . , u_{N}_{ₚₒₒₗ}₋₁}). A slot set of a resource pool uᵢ (0≤i<Nₚₒₒₗ) is denoted as

$${T}_{{u}_{l}}^{SL} = \{ {t}_{0}^{{′}^{SL , {u}_{i}}} , {t}_{1}^{{′}^{SL , {u}_{i}}} , … , {t}_{{R}_{max}^{{′}^{{u}_{i}}} - 1}^{{′}^{SL , {u}_{i}}} \}$$

where T′ₘₐₓ^{u}^{ᵢ} is the number of elements in the set Tᵤ_{ᵢ}^{SL}.

Optionally, the resource pool set U (or a subset of the resource pool set U) may be indicated by the first protocol layer entity to the second protocol layer entity.

Optionally, the resource pool set U(or a subset of the resource pool set U) may be an input parameter for triggering Embodiment 1 of the present invention (or triggering step S101).

Optionally, the resource pool set U(or a subset of the resource pool set U) may be a predefined or configured or pre-configured set.

Optionally, the resource pool set U is equal to a union of a set (for example, denoted as U_{TX}) consisting of N_{TX,pool} transmitting resource pools (or TX resource pools, or TX pools) and a set (for example, denoted as U_{RX}) consisting of N_{RX,pool} receiving resource pools (or RX resource pools, or RX pools), wherein
Optionally, an intersection of the set U_{TX} and the set U_{RX} is an empty set.
Optionally, an intersection of the set U_{TX} and the set U_{RX} is a nonempty set.
Optionally, N_{TX,pool} may be an integer greater than or equal to zero.
Optionally, N_{TX,pool} may be an integer greater than or equal to one.
Optionally, the set U_{TX} (or a subset of the set U_{TX}) may be indicated by the first protocol layer entity to the second protocol layer entity.
Optionally, the set U_{TX} (or a subset of the set U_{TX}) may be an input parameter for triggering Embodiment 1 of the present invention (or triggering step S101).
Optionally, the set U_{TX} (or a subset of the set U_{TX}) may be a predefined or configured or pre-configured set.
Optionally, N_{RX,pool} may be an integer greater than or equal to zero.
Optionally, N_{RX,pool} may be an integer greater than or equal to one.
Optionally, the set U_{RX} (or a subset of the set U_{RX}) may be indicated by the first protocol layer entity to the second protocol layer entity.
Optionally, the set U_{RX} (or a subset of the set U_{RX}) may be an input parameter for triggering Embodiment 1 of the present invention (or triggering step S101).
Optionally, the set U_{RX} (or a subset of the set U_{RX}) may be a predefined or configured or pre-configured set.

Optionally, the “one or more pieces of information related to inter-UE coordination” includes Nₛₗₒₜ slots (for example, denoted as a slot set

$${T}_{in}^{SL} = \{ {t}_{{y}_{( o )}}^{SL , in} , {t}_{{y}_{( 1 )}}^{SL , in} , … , {t}_{{y}_{( {N}_{slot} - 1 )}}^{{′}^{SL , in}} \} ) ,$$

wherein
Optionally, the Nₛₗₒₜ slots may belong to a slot set

$${T}_{u}^{SL} = \{ {t}_{0}^{{′}^{SL , u}} , {t}_{1}^{{′}^{SL , u}} , … , {t}_{{T}_{max}^{{′}^{u}} - 1}^{{′}^{SL , u}} \}$$

of a resource pool (for example, denoted as u).
Optionally, the Nₛₗₒₜ slots may belong to the “SL slot” set Tₐₗₗ^{SL}={t₀^{SL}, t₁^{SL}, . . . , t_{T}_{ₘₐₓ}₋₁^{SL}}.
Optionally, the Nₛₗₒₜ slots may belong to a set Tₐₗₗ={0,1, . . . ,10240×2^{μ}^{_{SL}}−1} of all the slots.

Optionally, the set Tᵢₙ^{SL} (or a subset of the set Tᵢₙ^{SL}) may be indicated by the first protocol layer entity to the second protocol layer entity.

Optionally, the set Tᵢₙ^{SL} (or a subset of the set Tᵢₙ^{SL}) may be an input parameter for triggering Embodiment 1 of the present invention (or triggering step S101).

Optionally, the set Tᵢₙ^{SL} (or a subset of the set Tᵢₙ^{SL}) may be a predefined or configured or pre-configured set.

Optionally, the “one or more pieces of information related to inter-UE coordination” includes information indicated in N_{SCI} SCIs (for example, denoted as an SCI set SCIᵢₙ^{SL}={SCI₀^{SL,in}, SCI₁^{SL,in}, . . . , SCI_{N}_{_{SCI}}₋₁^{SL,in}}), wherein
Optionally, for one or more (for example, all) integers n₁ satisfying 0≤n₁^{<N}_{SCI}, SCIₙ_{₁}^{SL,in} is SCI transmitted in the Nₚₒₒₗ resource pools.
Optionally, for one or more (for example, all) integers n₁ satisfying 0≤n₁<N_{SCI}, SCIₙ_{₁}^{SL,in} is SCI transmitted in the N_{TX,pool} transmitting resource pools.
Optionally, for one or more (for example, all) integers n₁ satisfying 0≤n₁<N_{SCI}, SCIₙ_{₁}^{SL,in} is SCI transmitted in the N_{RX,pool} receiving resource pools.
Optionally, for one or more (for example, all) integers n₁ satisfying 0≤n₁<N_{SCI}, SCIₙ_{₁}^{SL,in} is SCI transmitted in the first time window [t_{sci,start}^{SL,in}, t_{sci,end}^{SL,in}].
Optionally, for one or more (for example, all) integers n₁ satisfying 0≤n₁<N_{SCI}, SCIₙ_{₁}^{SL,in} is SCI detected (or received) by the UE (for example, SCI transmitted by another UE).
Optionally, for one or more (for example, all) integers n₁ satisfying 0≤n₁<N_{SCI}, SCIₙ_{₁}^{SL,in} is SCI transmitted by the UE.

In addition, in step S103, several resources related to inter-UE coordination are determined. For example, the number of the resources related to inter-UE coordination is denoted as N_{co}^{SL}, and a resource set corresponding to the N_{co}^{SL} resources is denoted as

$${R}_{co}^{SL} = \{ {r}_{0}^{SL , co} , {r}_{1}^{SL , co} , ⋯ ⋯ , {r}_{{N}_{co}^{SL} - 1}^{SL , co} \} .$$

In addition, if a slot where the resource rⱼ^{SL,co} is located is denoted as t_{y}_{₍ⱼ₎}^{SL,co}, a slot set corresponding to the set R_{co}^{SL} is

$${T}_{co}^{SL} = \{ {t}_{{y}_{( o )}}^{SL , co} , {t}_{{y}_{( 1 )}}^{SL , co} , … , {t}_{{y}_{( {N}_{co}^{SL} - 1 )}}^{SL , co} ) .$$

Optionally, N_{co}^{SL} may be an integer greater than or equal to zero. Optionally, N_{co}^{SL}=0, the set R_{co}^{SL} is an empty set (for example, denoted as Rᵢₙ^{SL}=∅).

Optionally, N_{co}^{SL} may be an integer greater than or equal to one.

Optionally, N_{co}^{SL} may be a predefined or configured or pre-configured value. For example, N_{co}^{SL}=4. As another example, N_{co}^{SL}=6. As another example, N_{co}^{SL}=8.

Optionally, N_{co}^{SL}≤N_{co,max}^{SL}. N_{co,max}^{SL} may be a predefined or configured or pre-configured value. For example, N_{co,max}^{SL}=3. As another example, N_{co,max}^{SL}=4. As another example, N_{co,max}^{SL}=5. As another example, N_{co,max}^{SL}6. As another example, N_{co,max}^{SL}=8.

Optionally, resources

$${r}_{0}^{SL , co} , {r}_{1}^{SL , co} , ⋯ ⋯ , {r}_{{N}_{co}^{SL} - 1}^{SL , co}$$

are arranged in chronological order. Correspondingly,

$${t}_{{y}_{( 0 )}}^{SL , co} < {t}_{{y}_{( 1 )}}^{SL , co} < ⋯ < {t}_{{y}_{( {N}_{co}^{SL} - 1 )}}^{SL , co} .$$

Optionally, for one or more integers j satisfying 0≤j<N_{co}^{SL}, the resource rⱼ^{SL,co} may be represented by only a time-domain resource (i.e., a corresponding slot t_{y}_{₍ⱼ₎}^{SL,co}), or the resource rⱼ^{SL,co} may correspond to a set of all possible sub-channels (e.g., a set corresponding to any one or more consecutive sub-channels) in the frequency domain in the slot t_{y}_{₍ⱼ₎}^{SL,co}.

Optionally, for one or more integers j satisfying 0≤j<N_{co}^{SL}, the resource rⱼ^{SL,co} may correspond to time-domain and frequency-domain information. For example, the resource rⱼ^{SL,co} corresponds to a slot t_{y}_{₍ⱼ₎}^{SL,co} in the time domain, and corresponds to one or more sub-channels (e.g., consecutive sub-channels) in the frequency domain.

Optionally, the N_{co}^{SL} resources may be represented by N_{res,set}^{SL,in} sets (for example, respectively denoted as

$${R}_{0}^{SL , co} , {R}_{1}^{SL , co} , ⋯ ⋯ , {R}_{{N}_{res , set}^{SL , in} - 1}^{SL , co} ) ,$$

wherein
Optionally, resources in the sets

$${R}_{0}^{SL , co} , {R}_{1}^{SL , co} , ⋯ ⋯ , {R}_{{N}_{res , set}^{SL , in} - 1}^{SL , co}$$

respectively belong to one of N_{res,set}^{SL,in} resource types indicated by C_{res,set}^{SL,in}. For example, the resources in the set R₀^{SL,co} belong to a first resource type indicated by C_{res,set}^{SL,in}, and the resources in the set R₁^{SL,co} belong to a second resource type indicated by C_{res,set}^{SL,in}, and so on.
Optionally, the sets

$${R}_{0}^{SL , co} , {R}_{1}^{SL , co} , ⋯ ⋯ , {R}_{{N}_{res , set}^{SL , in} - 1}^{SL , co}$$

are mutually disjoint subsets of the set R_{co}^{SL}.
Optionally, the set R_{co}^{SL} is a union of the sets

$${R}_{0}^{SL , co} , {R}_{1}^{SL , co} , ⋯ ⋯ , {R}_{{N}_{res , set}^{SL , in} - 1}^{SL , co} .$$

Optionally, the “resource type” of all resources in the resource set R_{co}^{SL} is “colliding resource”.

Optionally, the “resource type” of all resources in the resource set R_{co}^{SL} is “non-preferred resource”.

Optionally, for one or more (for example, all) integers j satisfying 0≤j<N_{co}^{SL}, the slot t_{y}_{₍ⱼ₎}^{SL,co} corresponding to the resource rⱼ^{SL,co} is in the second time window [t_{res,start}^{SL,in},t_{res,end}^{SL,in}].

Optionally, a step of determining the set R_{co}^{SL} may include one or more of the following:
initializing the set R_{co}^{SL} to be an empty set;
performing a sensing operation on the basis of one or more resource pools in the resource pool set U (for example, the N_{TX,pool} transmitting resource pools, as another example, the N_{RX,pool} receiving resource pools, and as another example, the Nₚₒₒₗ resource pools);
if the slot t_{y}_{₍ⱼ₎}^{SL} satisfies a first resource reservation condition, determining the slot t_{y}_{₍ⱼ₎}^{SL} as a slot (or resource) for inter-UE coordination;
if the slot t_{y}_{₍ⱼ₎}^{SL} satisfies the first resource reservation condition, adding the slot t_{y}_{₍ⱼ₎}^{SL} to the set R_{co}^{SL};
if the slot t_{y}_{₍ⱼ₎}^{SL} satisfies the first resource reservation condition, adding the slot t_{y}_{₍ⱼ₎}^{SL} to one of the N_{res,set}^{SL,in} sets

$$( {R}_{0}^{SL , co} , {R}_{1}^{SL , co} , ⋯ ⋯ , {R}_{{N}_{res , set}^{SL , in} - 1}^{SL , co} )$$

corresponding to the resource type “colliding resource”;
if the slot t_{y}_{₍ⱼ₎}^{SL} satisfies the first resource reservation condition, adding the slot t_{y}_{₍ⱼ₎}^{SL} to one of the N_{res,set}^{SL,in} sets

$$( {R}_{0}^{SL , co} , {R}_{1}^{SL , co} , ⋯ ⋯ , {R}_{{N}_{res , set}^{SL , in} - 1}^{SL , co} )$$

corresponding to the resource type “non-preferred resource”.

Optionally, for the slot t_{y}_{₍ⱼ₎}^{SL} the first resource reservation condition includes one or more of the following (in any combination of “and” or “or” where applicable):
The slot t_{y}_{₍ⱼ₎}^{SL} is in the second time window [t_{res,start}^{SL,in},t_{res,end}^{SL,in}].
The slot t_{y}_{₍ⱼ₎}^{SL} is in a slot set respectively corresponding to one (or, one or more) resource pool in the resource pool set U.
The slot t_{y}_{₍ⱼ₎}^{SL} is in a slot set respectively corresponding to one (or, one or more) resource pool in the transmitting resource pool set U_{TX}.
The slot t_{y}_{₍ⱼ₎}^{SL} is in a slot set respectively corresponding to one (or, one or more) resource pool in the receiving resource pool set U_{RX}.
Resources in the slot t_{y}_{₍ⱼ₎}^{SL} are reserved (and/or assigned) in two (or, two or more) of the N_{SCI} SCIs (for example, resources in any resource pool including the slot t_{y}_{₍ⱼ₎}^{SL} in the resource pool set U; as another example, resources in any resource pool including the slot t_{y}_{₍ⱼ₎}^{SL} in the transmitting resource pool set U_{TX}; as another example, resources in any resource pool including the slot t_{y}_{₍ⱼ₎}^{SL} in the receiving resource pool set U_{RX}).
Resources in the slot t_{y}_{₍ⱼ₎}^{SL} are reserved (and/or assigned) in one (or, one or more; or, two or more) SCI satisfying a first SCI condition among the N_{SCI} SCIs (for example, resources in any resource pool including the slot t_{y}_{₍ⱼ₎}^{SL} in the resource pool set U; as another example, resources in any resource pool including the slot t_{y}_{₍ⱼ₎}^{SL} in the transmitting resource pool set U_{TX}; as another example, resources in any resource pool including the slot t_{y}_{₍ⱼ₎}^{SL} in the receiving resource pool set U_{RX}).
Resources in the slot t_{y}_{₍ⱼ₎}^{SL} are reserved (and/or assigned) in one (or, one or more; or, two or more) SCI not satisfying the first SCI condition among the N_{SCI} SCIs (for example, resources in any resource pool including the slot t_{y}_{₍ⱼ₎}^{SL} in the resource pool set U; as another example, resources in any resource pool including the slot t_{y}_{₍ⱼ₎}^{SL} in the transmitting resource pool set U_{TX}; as another example, resources in any resource pool including the slot t_{y}_{₍ⱼ₎}^{SL} in the receiving resource pool set U_{RX}).
Resources in the slot t_{y}_{₍ⱼ₎}^{SL} are reserved (and/or assigned) in one (or, one or more; or, two or more) SCI satisfying a second SCI condition among the N_{SCI} SCIs (for example, resources in any resource pool including the slot t_{y}_{₍ⱼ₎}^{SL} in the resource pool set U; as another example, resources in any resource pool including the slot t_{y}_{₍ⱼ₎}^{SL} in the transmitting resource pool set U_{TX}; as another example, resources in any resource pool including the slot t_{y}_{₍ⱼ₎}^{SL} in the receiving resource pool set U_{RX}).
Resources in the slot t_{y}_{₍ⱼ₎}^{SL} are reserved (and/or assigned) in one (or, one or more; or, two or more) SCI not satisfying the second SCI condition among the N_{SCI} SCIs (for example, resources in any resource pool including the slot t_{y}_{₍ⱼ₎}^{SL} in the resource pool set U; as another example, resources in any resource pool including the slot t_{y}_{₍ⱼ₎}^{SL} in the transmitting resource pool set U_{TX}; as another example, resources in any resource pool including the slot t_{y}_{₍ⱼ₎}^{SL} in the receiving resource pool set U_{RX}).
The slot t_{y}_{₍ⱼ₎}^{SL} is a slot in the slot set Tᵢₙ^{SL}.
The UE is scheduled with one (or, one or more) SL transmission in the slot t_{y}_{₍ⱼ₎}^{SL}.
The UE is scheduled with one (or, one or more) UL transmission in the slot t_{y}_{₍ⱼ₎}^{SL}.
The UE cannot perform SL transmission in the slot t_{y}_{₍ⱼ₎}^{SL} (for example, due to the capability limitations of the UE).
The UE cannot perform SL reception in the slot t_{y}_{₍ⱼ₎}^{SL} (for example, due to the capability limitations of the UE).

Optionally, for any one of the N_{SCI} SCIs, the first SCI condition includes one or more of the following (in any combination of “and” or “or” where applicable):
The SCI is SCI detected (or received) by the UE (for example, SCI transmitted by another UE).
The SCI is SCI transmitted in the Nₚₒₒₗ resource pools.
The SCI is SCI transmitted in the N_{TX,pool} transmitting resource pools.
The SCI is SCI transmitted in the N_{RX,pool} receiving resource pools.
The SCI is SCI transmitted in the first time window [t_{sci,start}^{SL,in},t_{sci,end}^{SL,in}].
The identifier indicated in the “destination ID” field in the SCI is equal to an identifier in the set Eᵢₙ^{SL}.
The identifier indicated in the “destination ID” field in the SCI is equal to a destination layer-1 identifier corresponding to an identifier in the set Eᵢₙ^{SL}.
The identifier indicated in the “destination ID” field in the SCI is equal to a source layer-1 identifier corresponding to an identifier in the set Eᵢₙ^{SL}.
The identifier indicated in the “source ID” field in the SCI is equal to an identifier in the set Eᵢₙ^{SL}.
The identifier indicated in the “source ID” field in the SCI is equal to a source layer-1 identifier corresponding to an identifier in the set Eᵢₙ^{SL}.
The identifier indicated in the “source ID” field in the SCI is equal to a destination layer-1 identifier corresponding to an identifier in the set Eᵢₙ^{SL}.
The identifier indicated in the “destination ID” field and the identifier indicated in the “source ID” field in the SCI are respectively equal to a “destination ID” (or a destination layer-1 identifier corresponding to the “destination ID”) and a “source ID” (or a source layer-1 identifier corresponding to the “source ID”) of an SL connection in the set Lᵢₙ^{SL}.
The identifier indicated in the “destination ID” field and the identifier indicated in the “source ID” field in the SCI are respectively equal to a “source ID” (or a source layer-1 identifier corresponding to the “source ID”) and a “destination ID” (or a destination layer-1 identifier corresponding to the “destination ID”) of an SL connection in the set Lᵢₙ^{SL}.
The identifier indicated in the “destination ID” field, the identifier indicated in the “source ID” field, and the cast type indicated in the “cast type” field in the SCI are respectively equal to a “destination ID” (or a destination layer-1 identifier corresponding to the “destination ID”), a “source ID” (or a source layer-1 identifier corresponding to the “source ID”), and the “cast type” of an SL connection in the set Lᵢₙ^{SL}.
The identifier indicated in the “destination ID” field, the identifier indicated in the “source ID” field, and the cast type indicated in the “cast type” field in the SCI are respectively equal to a “source ID” (or a source layer-1 identifier corresponding to the “source ID”), a “destination ID” (or a destination layer-1 identifier corresponding to the “destination ID”), and the “cast type” of an SL connection in the set Lᵢₙ^{SL}.

Optionally, for any one of the N_{SCI} SCIs, the second SCI condition includes one or more of the following (in any combination of “and” or “or” where applicable):
The SCI is SCI transmitted by the UE.
The SCI is SCI transmitted in the Nₚₒₒₗ resource pools.
The SCI is SCI transmitted in the N_{TX,pool} transmitting resource pools.
The SCI is SCI transmitted in the N_{RX,pool} receiving resource pools.
The SCI is SCI transmitted in the first time window [t_{sci,start}^{SL,in},t_{sci,end}^{SL,in}].
The identifier indicated in the “destination ID” field in the SCI is equal to an identifier in the set Eᵢₙ^{SL}.
The identifier indicated in the “destination ID” field in the SCI is equal to a destination layer-1 identifier corresponding to an identifier in the set Eᵢₙ^{SL}.
The identifier indicated in the “destination ID” field in the SCI is equal to a source layer-1 identifier corresponding to an identifier in the set Eᵢₙ^{SL}.
The identifier indicated in the “source ID” field in the SCI is equal to a source layer-1 identifier of the UE.
The identifier indicated in the “source ID” field in the SCI is equal to a source layer-1 identifier corresponding to a source layer-2 identifier of the UE.
The identifier indicated in the “destination ID” field and the identifier indicated in the “source ID” field in the SCI are respectively equal to a “destination ID” (or a destination layer-1 identifier corresponding to the “destination ID”) and a “source ID” (or a source layer-1 identifier corresponding to the “source ID”) of an SL connection in the set Lᵢₙ^{SL}.
The identifier indicated in the “destination ID” field and the identifier indicated in the “source ID” field in the SCI are respectively equal to a “source ID” (or a source layer-1 identifier corresponding to the “source ID”) and a “destination ID” (or a destination layer-1 identifier corresponding to the “destination ID”) of an SL connection in the set Lᵢₙ^{SL}.
The identifier indicated in the “destination ID” field, the identifier indicated in the “source ID” field, and the cast type indicated in the “cast type” field in the SCI are respectively equal to a “destination ID” (or a destination layer-1 identifier corresponding to the “destination ID”), a “source ID” (or a source layer-1 identifier corresponding to the “source ID”), and the “cast type” of an SL connection in the set Lᵢₙ^{SL}.
The identifier indicated in the “destination ID” field, the identifier indicated in the “source ID” field, and the cast type indicated in the “cast type” field in the SCI are respectively equal to a “source ID” (or a source layer-1 identifier corresponding to the “source ID”), a “destination ID” (or a destination layer-1 identifier corresponding to the “destination ID”), and the “cast type” of an SL connection in the set Lᵢₙ^{SL}.

In addition, optionally, in step S105, the several resources are indicated to another protocol entity. For example, the resource set R_{co}^{SL} is indicated to the first protocol layer entity (for example, the second protocol layer entity performing step S105 indicates the resource set R_{co}^{SL} to the first protocol layer entity).

Optionally, in Embodiment 1 of the present invention, the first protocol layer entity is a MAC layer (or referred to as MAC sub-layer) protocol entity, or an RLC layer protocol entity, or a PDCP layer protocol entity, or an RRC layer protocol entity, or a PC5-RRC layer protocol entity, or a PC5-S layer protocol entity, or a physical layer (or referred to as PHY layer) protocol entity.

Optionally, in Embodiment 1 of the present invention, the second protocol layer entity is a physical layer (or referred to as PHY layer) protocol entity, or a MAC layer (or referred to as MAC sub-layer) protocol entity, or an RLC layer protocol entity, or a PDCP layer protocol entity, or an RRC layer protocol entity, or a PC5-RRC layer protocol entity, or a PC5-S layer protocol entity.

Optionally, in Embodiment 1 of the present invention, step S101, step S103, and step S105 are performed by the second protocol layer entity of the UE (where applicable).

Thus, according to Embodiment 1, in the method provided in the present invention, a suitable filtering condition is set in the process of determining an inter-UE coordination resource set, so as to reduce SCIs that need to be analyzed and processed, thereby ensuring that an inter-UE coordination function is executed only for a destination UE or an SL connection satisfying a certain condition, while preventing a large number of messages indicating the same or similar inter-UE coordination resources from being present on an SL at the same time to block the SL.

### Embodiment 2

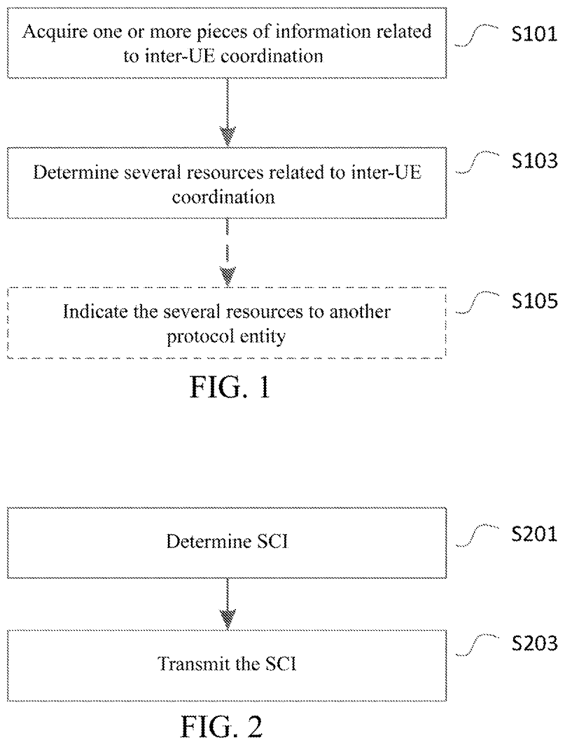

A method performed by user equipment according to Embodiment 2 of the present invention will be described below with reference to FIG. 2.

FIG. 2 is a flowchart showing a method performed by user equipment according to Embodiment 2 of the present invention.

As shown in FIG. 2, in Embodiment 2 of the present invention, the steps performed by the user equipment (UE) include: step S201 and step S203. For convenience, the UE may also be referred to as “UE A”.

Specifically, in step S201, SCI is determined. For example, the value of one or more fields in a 1^{st}-stage SCI format and/or a 2^{nd}-stage SCI format corresponding to the SCI is determined.

Optionally, the 1^{st}-stage SCI format may be SCI format 1-A or another 1^{st}-stage SCI format.

Optionally, the 2^{nd}-stage SCI format may be SCI format 2-A or SCI format 2-B or another 2^{nd}-stage SCI format.

Optionally, the SCI may correspond to (or be associated with) one “destination UE”. For example, the destination UE may be a UE corresponding to or indicated in the “destination ID” field in the 2^{nd}-stage SCI format. For convenience, the destination UE may also be referred to as “UE B”.

Optionally, UE B may correspond to more than one UE (e.g., when the SL transmission corresponding to or associated with the 1^{st}-stage SCI format is a broadcast transmission or a groupcast transmission).

For convenience, a set of resources indicated by the SCI (for example, indicated in the “frequency resource assignment” and/or “time resource assignment” fields in the 1^{st}-stage SCI format) is denoted as

$${R}_{rsvp}^{SL , u} = \{ {r}_{0}^{SL , u , rsvp} , … , {R}_{{N}_{rsvp}^{SL , u} - 1}^{SL , u , rsvp} \} ,$$

and correspondingly, and slots where

$${r}_{0}^{SL , u , rsvp} , … , {r}_{{N}_{rsvp}^{SL , u} - 1}^{SL , u , rsvp}$$

are located are respectively denoted as

$${t}_{{y}_{o}}^{{′}^{SL , u}} , … , {t}_{{y}_{{N}_{rsvp}^{SL , u} - 1}}^{{′}^{SL , u}} ,$$

wherein
u is a resource pool corresponding to the resources in the set Rᵣₛᵥₚ^{SL,u}. Optionally, the resource pool u is a resource pool in a resource pool set U_{m2,TX}. The resource pool set U_{m2,TX} may be configured or pre-configured by means of one or more higher layer protocol parameters. For example, the resource pool set U_{m2,TX} is configured by means of a parameter sl-TxPoolSelectedNormal. As another example, the resource pool set U_{m2,TX} is configured by means of a parameter sl-TxPoolExceptional. As another example, the resource pool set U_{m2,TX} is configured by means of the parameter sl-TxPoolSelectedNormal and the parameter sl-TxPoolExceptional collectively.
Nᵣₛᵥₚ^{SL,u} is the number of elements in the set Rᵣₛᵥₚ^{SL,u}. For example, Nᵣₛᵥₚ^{SL,u}=1. As another example, Nᵣₛᵥₚ^{SL,u}=2. As another example, Nᵣₛᵥₚ^{SL,u}=3.
Optionally, r₀^{SL,u,rsvp} is an SL resource corresponding to a PSCCH corresponding to (or associated with) the SCI and/or a corresponding PSSCH. Correspondingly, the slot t′_{y}_{₀}^{SL,u} is a slot where the PSCCH corresponding to (or associated with) the SCI and/or the corresponding PSSCH is located.

For convenience,

$${\overline{R}}_{rsvp}^{SL , u} = \{ {r}_{1}^{SL , u , rsvp} , … , {R}_{{N}_{rsvp}^{SL , u} - 1}^{SL , u , rsvp} \} .$$

For example, if Nᵣₛᵥₚ^{SL,u}=2, then Rᵣₛᵥₚ^{SL,u}={r₀^{SL,u,rsvp},r₁^{SL,u,rsvp}}, R̅ᵣₛᵥₚ^{SL,u}={r₁^{SL,u,rsvp}}. As another example, if Nᵣₛᵥₚ^{SL,u}=1, then Rᵣₛᵥₚ^{SL}={r₀^{SL,u,rsvp}}, R̅ᵣₛᵥₚ^{SL,u} an empty set.

Optionally, the resource type corresponding to the resource r₀^{SL,u,rsvp} is “reserved resource” (or “resource being reserved”, or “resource to be reserved”, or “resource for reservation”, or “allocated resource”, or “resource being allocated”, or “resource to be allocated”, or “resource for allocation”).

Optionally, when i is different (0≤i<Nᵣₛᵥₚ^{SL,u}, or 1≤i<Nᵣₛᵥₚ^{SL,u}), the resource type corresponding to the resource rᵢ^{SL,u,rsvp} may be different. Specifically, for example, the resource type corresponding to the resource rᵢ^{SL,u,rsvp} may be one of the following:
“Reserved resource” (or “resource being reserved”, or “resource to be reserved”, or “resource for reservation”, or “allocated resource”, or “resource being allocated”, or “resource to be allocated”, or “resource for allocation”).
“Released resource” (or “resource being released”, or “resource to be released”, or “resource for release”).
“Colliding resource”.
“Preferred resource”.
“Non-preferred resource”.
“Inter-UE coordination resource”. For example, the “inter-UE coordination resource” may be a general name of one or more resource types. Optionally, the actual resource type (e.g., “reserved resource”, or “allocated resource”, or “released resource”, or “colliding resource”, or “preferred resource”, or “non-preferred resource”) may be configured or pre-configured by means of a higher layer parameter, or indicated by means of a MAC CE, or indicated by means of SCI (e.g., the SCI).

Optionally, the SCI may indicate resource types respectively corresponding to one or more (for example, all) resources in the set Rᵣₛᵥₚ^{SL,u} (or the set R̅ᵣₛᵥₚ^{SL,u}). For example, each value (or each valid value) of a field (for example, referred to as the “resource type” field) in the “SCI format” (or SCI format combination) respectively indicates one resource type combination (for example, a combination of resource types respectively corresponding to the resources

$${r}_{0}^{SL , u , rsvp} , … , {r}_{{N}_{rsvp}^{SL , u} - 1}^{SL , u , rsvp} ;$$

as another example, a combination of resource types respectively corresponding to

$${r}_{1}^{SL , u , rsvp} , … , {r}_{{N}_{rsvp}^{SL , u} - 1}^{SL , u , rsvp} ) .$$

Optionally, one or more values (for example, referred to as “invalid values”) of the “resource type” field do not indicate any resource type combination.

For example, Nᵣₛᵥₚ^{SL,u}=2, and two values of the “resource type” field respectively indicate combinations of resource types respectively corresponding to the resources in the set R̅ᵣₛᵥₚ^{SL,u}={r₁^{SL,u,rsvp}}. Specifically, for example, “0” indicates that the resource r₁^{SL,u,rsvp} is a reserved resource, and “1” indicates that the resource r₁^{SL,u,rsvp} is a colliding resource.

As another example, Nᵣₛᵥₚ^{SL,u}=3, and four values of the “resource type” field respectively indicate combinations of resource types respectively corresponding to the resources in the set R̅ᵣₛᵥₚ^{SL,u}={r₁^{SL,u,rsvp},r₂^{SL,u,rsvp}}. Specifically, for example, “0” indicates that the resource r₁^{SL,u,rsvp} and the resource r₂^{SL,u,rsvp} are both reserved resources; “1” indicates that the resource r₁^{SL,u,rsvp} is a reserved resource, and the resource r₂^{SL,u,rsvp} is a colliding resource; “2” indicates that the resource r₁^{SL,u,rsvp} is a colliding resource, and the resource r₂^{SL,u,rsvp} is a reserved resource; “3” indicates that the resource r₁^{SL,u,rsvp} and the resource r₂^{SL,u,rsvp} are both colliding resources.

Optionally, under a certain condition (for example, when the corresponding resource type is a predefined or configured or pre-configure value, or when the corresponding resource type is one of several predefined or configured or pre-configure values, or depending on configuration of another higher layer parameter, or according to an indication in the “frequency resource assignment” field or another field in the SCI), the resource rᵢ^{SL,u,rsvp} (0≤i<Nᵣₛᵥₚ^{SL,u}, or 1≤i<Nᵣₛᵥₚ^{SL,u}) may be represented by only a time resource (e.g., a corresponding slot t′_{y}_{ᵢ}^{SL,u}). For example, the resource rᵢ^{SL,u,rsvp} may correspond to a set consisting of all sub-channels in the frequency domain in the slot t′_{y}_{ᵢ}^{SL,u} in the resource pool u, or a set of all possible sub-channels (e.g., a set corresponding to any one or more consecutive sub-channels).

In addition, in step S203, the SCI is transmitted.

For example, the PSCCH and/or the PSSCH corresponding to (or associated with) the SCI is transmitted in the slot t′_{y}_{₀}^{SL,u} in the resource pool u.
Optionally, the PSCCH carries the 1^{st}-stage SCI format.
Optionally, the PSSCH carries the 2^{nd}-stage SCI format.
Optionally, the starting PRB of the PSCCH is the lowest PRB in the lowest sub-channel corresponding to the PSSCH.

Optionally, in Embodiment 2 of the present invention, “resource type” may be replaced with “resource state” or “resource feature” or “resource use”.

Optionally, in Embodiment 2 of the present invention, the “colliding resource” may be determined according to the method described in Embodiment 1 of the present invention.

Optionally, in Embodiment 2 of the present invention, the “non-preferred resource” may be determined according to the method described in Embodiment 1 of the present invention.

Thus, according to Embodiment 2, in the method provided in the present invention, a resource type indication is added to the existing SCI format, so that a resource reserved by TX UE for itself and/or a resource for inter-UE coordination (e.g., a resource reserved for RX UE, a resource having a detected collision, etc.) can also be indicated in the existing SCI format in a backward compatible manner, thereby implementing inter-UE coordination functions with exceedingly low signaling overhead.

### Embodiment 3

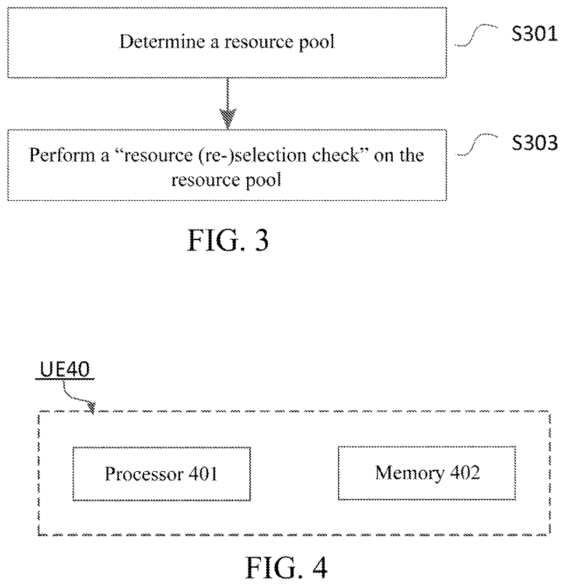

A method performed by user equipment according to Embodiment 3 of the present invention will be described below with reference to FIG. 3.

FIG. 3 is a flowchart showing a method performed by user equipment according to Embodiment 3 of the present invention.

As shown in FIG. 3, in Embodiment 3 of the present invention, the steps performed by the user equipment (UE) include: step S301 and step S303.

Specifically, in step S301, a resource pool (for example, denoted as u) is determined.

Optionally, the resource pool u is a transmitting resource pool.

Optionally, the resource pool u is a resource pool in a resource pool set U_{m2,TX}. The resource pool set U_{m2,TX} may be configured or pre-configured by means of one or more higher layer protocol parameters. For example, the resource pool set U_{m2,TX} is configured by means of the parameter sl-TxPoolSelectedNormal. As another example, the resource pool set U_{m2,TX} is configured by means of the parameter sl-TxPoolExceptional. As another example, the resource pool set U_{m2,TX} is configured by means of the parameter sl-TxPoolSelectedNormal and the parameter sl-TxPoolExceptional collectively.

Optionally, when a first SL transmission condition is satisfied, the resource pool u is determined. The first SL transmission condition may include one or more of the following (in any combination of “and” or “or”):
The UE has been configured to use SL resource allocation mode 2. Correspondingly, optionally, the UE determines, on the basis of sensing and/or partial sensing and/or random selection (or random resource selection) and/or other resource selection mechanisms, that SL transmission is performed on one (or, one or more) resource pool in an SL carrier.
Data needs to be transmitted on one (or, one or more) logical channel, wherein
   Optionally, the UE has not selected a resource pool for the one (or more) logical channel. Optionally, the “resource pool” is a resource pool on which transmission of data for the logical channel is allowed.
The UE has created a sidelink (SL) grant (or referred to as “selected sidelink grant”), wherein
   Optionally, the SL grant corresponds to transmission of one MAC PDU.
   Optionally, the SL grant corresponds to transmission of a plurality of MAC PDUs.
   Optionally, the term “create” may also be referred to as “select to create”.

Optionally, the resource pool u is determined for a sidelink (SL) process (for example, denoted as Pᵤ^{SL}).

Optionally, a resource pool is determined for each SL process satisfying the first SL transmission condition.

Optionally, the resource pool u is a resource pool randomly selected (for example, randomly selected according to an equal probability) from the resource pool set U_{m2,TX}, or a resource pool that is randomly selected, or a resource pool determined in another manner.

In addition, optionally, in step S303, a “resource (re-)selection check” (or referred to as “TX resource (re-)selection check”) is performed on the resource pool u.

Optionally, the “resource (re-)selection check” is not only applicable to resource selection, but also applicable to resource reselection.

Optionally, the “resource (re-)selection check” is performed for the SL process pᵤ^{SL}.

Optionally, if a first resource (re-)selection condition is satisfied, one or more of the following are performed:
Removing the SL grant associated with the SL process pᵤ^{SL}. For example, if the SL grant is available, the SL grant is removed.
Triggering resource (re-)selection (or referred to as “TX resource (re-)selection).

Optionally, the “first resource (re-)selection condition” may include one or more of the following (in any combination of “and” or “or” where applicable):
The value of an SL resource reselection counter (e.g., represented by SL_RESOURCE_RESELECTION_COUNTER) is 0, and when SL_RESOURCE_RESELECTION_COUNTER is equal to 1, a value randomly selected by the UE in the interval [0, 1] according to an equal probability is greater than (or, greater than or equal to) a configured value (for example, a value configured by means of an RRC parameter sl-ProbResourceKeep).
The resource pool u is configured or reconfigured, for example, configured or reconfigured by means of RRC.
No corresponding SL grant is present in the resource pool u.
In a past period of time (e.g., in the past one second), no transmission or retransmission was performed on any resource indicated in the SL grant.
Among transmission opportunities corresponding to resources indicated in the SL grant, the number of consecutive, unused transmission opportunities reaches (or is equal to) a given value (e.g., a value configured by means of a parameter sl-ReselectAfter).
The SL grant cannot accommodate an RLC SDU (e.g., the RLC SDU cannot be accommodated even when the allowed maximum MCS is used), and the UE selects not to segment the RLC SDU.
Transmission performed by using the SL grant (e.g., transmission on one or more or any resource indicated in the SL grant) cannot satisfy a latency requirement on data in a corresponding logical channel (e.g., in the case that a corresponding priority is considered), and the UE selects not to perform transmission corresponding to a MAC PDU.
A protocol layer entity (for example, a physical layer protocol entity, and as another example, an RRC layer protocol entity) of the UE indicates resource (re-)selection. For example, since the received SCI (for example, the SCI determined according to the method in Embodiment 2 of the present invention) indicates one or more “colliding resources” (or one or more “preferred resources”, or one or more “non-preferred resources”), the physical layer protocol entity of the UE indicates resource (re-)selection to the MAC layer protocol entity of the UE.
A protocol layer entity (for example, a physical layer protocol entity, and as another example, an RRC layer protocol entity) of the UE indicates that a “colliding resource” (or “preferred resource”, or “non-preferred resource”, or “inter-UE coordination resource”) is present. For example, since the received SCI (for example, the SCI determined according to the method in Embodiment 2 of the present invention) indicates one or more “colliding resources” (or one or more “preferred resources”, or one or more “non-preferred resources”), the physical layer protocol entity of the UE indicates, to the MAC layer protocol entity of the UE, that a “colliding resource” (or “preferred resource”, or “non-preferred resource”, or “inter-UE coordination resource”) is present.
A protocol layer entity (for example, a physical layer protocol entity, and as another example, an RRC layer protocol entity) of the UE indicates one or more “colliding resources” (or “preferred resources”, or “non-preferred resources”, or “inter-UE coordination resources”). For example, since the received SCI (for example, the SCI determined according to the method in Embodiment 2 of the present invention) indicates one or more “colliding resources” (or one or more “preferred resources”, or one or more “non-preferred resources”), the physical layer protocol entity of the UE indicates the one or more “colliding resources” (or “preferred resources”, or “non-preferred resources”, or “inter-UE coordination resources”) to the MAC layer protocol entity of the UE.
The received SCI (for example, the SCI determined according to the method in Embodiment 2 of the present invention) indicates one or more “colliding resources” (or one or more “preferred resources”, or one or more “non-preferred resources”, or one or more “inter-UE coordination resources”).
N_{co,count}^{SL,u} resources satisfying a first SL resource type condition are present in the SL grant (or, in one or more resources indicated by the SL grant), wherein
   Optionally, N_{co,count}^{SL,u} is a predefined or configured or pre-configured integer. For example, N_{co,count}^{SL,u}=1.
   Optionally, N_{co,count}^{SL,u}≥N_{co,min}^{SL,u}, where N_{co,min}^{SL,u} is a predefined or configured or pre-configured integer (e.g., N_{co,min}^{SL,u}=1).
   Optionally, for a resource (for example, denoted as rᵢ^{SL,u}) indicated by the SL grant, the first SL resource type condition may include one or more of the following (in any combination of “and” or “or” where applicable):
      The resource rᵢ^{SL,u} overlaps with one (or, one or more) resource in a resource set R.
      The resource rᵢ^{SL,u} overlaps with one (or, one or more) “reserved resource” in the resource set R.
      The resource rᵢ^{SL,u} overlaps with one (or, one or more) “allocated resource” in the resource set R.
      The resource rᵢ^{SL,u} overlaps with one (or, one or more) “colliding resource” in the resource set R.
      The resource rᵢ^{SL,u} overlaps with one (or, one or more) “preferred resource” in the resource set R.
      The resource rᵢ^{SL,u} overlaps with one (or, one or more) “non-preferred resource” in the resource set R.
   wherein
      Optionally, the resource set R is a resource set indicated in an inter-UE coordination message received by the UE (for example, transmitted by another UE) (for example, the resource set R_{co}^{SL} related to inter-UE coordination and determined according to the method in Embodiment 1 of the present invention).
      Optionally, for a resource X and a resource Y, the term “overlap” may mean that the resource X and the resource Y are in the same slot of the same resource pool, and frequency-domain resources corresponding to the resource X and the resource Y overlap in one or more sub-channels (or resource blocks, or resource block groups, or resource elements, or subcarriers).
      Optionally, for a resource X and a resource Y, the term “overlap” may mean that the resource X and the resource Y are in the same slot. For example, the resource X and the resource Y are in the same slot of the same resource pool, and frequency-domain resources corresponding to the resource X and the resource Y overlap in one or more sub-channels (or resource blocks, or resource block groups, or resource elements, or subcarriers). As another example, the resource X and the resource Y are in the same slot of the same resource pool, and frequency-domain resources corresponding to the resource X and the resource Y do not overlap with each other, for example, do not overlap with each other in any sub-channel (or resource block, or resource block group, or resource element, or subcarrier). As another example, the resource X and the resource Y are in the same slot of different resource pools, and frequency-domain resources corresponding to the resource X and the resource Y do not overlap with each other, for example, do not overlap with each other in any sub-channel (or resource block, or resource block group, or resource element, or subcarrier).

Optionally, in Embodiment 3 of the present invention, step S301 and/or step S303 is performed by a MAC sub-layer (or referred to as MAC layer) protocol entity of the UE (e.g., in the corresponding step, “the UE” may be replaced with “the MAC sub-layer protocol entity of the UE”).

Thus, according to Embodiment 3, in the method provided in the present invention, a new resource (re-)selection condition is introduced, so that when a UE receives an inter-UE coordination message from another UE, resource reselection can be performed in a timely manner, thereby greatly reducing SL transmission performance loss caused by colliding resources reserved by different UEs or the like.

### Variant Embodiment

Hereinafter, FIG. 4 is used to illustrate user equipment that can perform the method performed by user equipment described in detail above in the present invention as a variant embodiment.

FIG. 4 shows a block diagram of user equipment (UE) according to the present invention.

As shown in FIG. 4, the user equipment (UE) 40 includes a processor 401 and a memory 402. The processor 401 may include, for example, a microprocessor, a microcontroller, an embedded processor, and the like. The memory 402 may include, for example, a volatile memory (such as a random access memory (RAM)), a hard disk drive (HDD), a non-volatile memory (such as a flash memory), or other memories. The memory 402 stores program instructions. The instructions, when run by the processor 401, can implement the above method performed by user equipment as described in detail in the present invention.

The method and related equipment according to the present invention have been described above in combination with preferred embodiments. It should be understood by those skilled in the art that the method shown above is only exemplary, and the above embodiments can be combined with one another as long as no contradiction arises. The method of the present invention is not limited to the steps or sequences illustrated above. The network node and user equipment illustrated above may include more modules. For example, the network node and user equipment may further include modules that can be developed or will be developed in the future to be applied to a base station, an AMF, a UPF, an MME, an S-GW, or UE, and the like. Various identifiers shown above are only exemplary, and are not meant for limiting the present invention. The present invention is not limited to specific information elements serving as examples of these identifiers. A person skilled in the art could make various alterations and modifications according to the teachings of the illustrated embodiments. Those skilled in the art should understand that part or all of the mathematical expressions, mathematical equations, or mathematical inequalities may be simplified or transformed or rewritten to some extent, for example, incorporating constant terms, or interchanging two addition terms, or interchanging two multiplication terms, or moving a term from the left side of an equation or inequality to the right side after changing the plus or minus sign thereof, or moving a term from the right side of an equation or inequality to the left side after changing the plus or minus sign thereof or the like. Mathematical expressions, mathematical equations, or mathematical inequalities before and after the simplification or transformation or rewriting may be considered to be equivalent to each other. Those skilled in the art would appreciate that a subset of a set may be the set itself. For example, a subset of A={a₁, a₂} may be {a₁, a₂}, or {a₁}, or {a₂}, or an empty set.

It should be understood that the above-described embodiments of the present invention may be implemented by software, hardware, or a combination of software and hardware. For example, various components of the base station and user equipment in the above embodiments can be implemented by multiple devices, and these devices include, but are not limited to: an analog circuit device, a digital circuit device, a digital signal processing (DSP) circuit, a programmable processor, an application specific integrated circuit (ASIC), a field programmable gate array (FPGA), and a complex programmable logic device (CPLD), and the like.

In the present invention, the term “base station” may refer to a mobile communication data and/or control switching center having specific transmission power and a specific coverage area and including functions such as resource allocation and scheduling, data reception and transmission, and the like. “User equipment” may refer to a user mobile terminal, for example, including terminal devices that can communicate with a base station or a micro base station wirelessly, such as a mobile phone, a laptop computer, and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (methods) described in the embodiments of the present invention. Such setting of the present invention is typically provided as software, codes and/or other data structures provided or encoded on the computer readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to execute various functions described in this description may include general-purpose processors, digital signal processors (DSPs), application specific integrated circuits (ASICs) or general-purpose integrated circuits, field programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1-2. (Canceled)

3. User equipment, comprising:
a processor; and
a memory storing instructions,
wherein the instructions, when run by the processor, cause the user equipment to:
upon triggering by a higher layer with indication information including
first information indicating a time window, and
second information indicating a type of resources, the type being selected from the group consisting of: preferred resources; and non-preferred resources,
determine a set of resources in the time window, wherein a type of the resources in the set is the type indicated by the indication information; and
report the set of resources to the higher layer.

4. A method performed by user equipment, comprising:
upon triggering by a higher layer with indication information including
first information indicating a time window, and
second information indicating a type of resources, the type being selected from the group consisting of: preferred resources; and non-preferred resources,
determining a set of resources in the time window, wherein a type of the resources in the set is the type indicated by the indication information; and
reporting the set of resources to the higher layer.
